(19) United States
(12) Patent Application Publication
(10) Pub. No.: US 2019/0113865 A1
(43) Pub. Date: Apr. 18, 2019

(54) DEVELOPER ACCOMMODATING MEMBER, DEVELOPER ACCOMMODATING UNIT, DEVELOPING DEVICE, PROCESS CARTRIDGE AND IMAGE FORMING APPARATUS

(71) Applicant: CANON KABUSHIKI KAISHA, Tokyo (JP)

(72) Inventors: Hiroomi Matsuzaki, Mishima-shi (JP); Kojiro Yasui, Numazu-shi (JP); Koji Yamaguchi, Numazu-shi (JP)

(21) Appl. No.: 16/158,908

(22) Filed: Oct. 12, 2018

(30) Foreign Application Priority Data
Oct. 16, 2017 (JP) 2017-199995

(51) Int. Cl. G03G 15/08

(52) U.S. Cl. CPC G03G 15/0874; G03G 2215/0682; G03G 15/0882

(57) ABSTRACT

A developer accommodating member for accommodating a developer includes a flexible container provided with a single opening for permitting discharge of the developer, a sealing member bonded to a periphery of the opening and configured to seal the opening, a bonding portion bonding the periphery of the opening and the sealing member, and a reinforcing member. The container includes a fixing portion fixable in a neighborhood of the opening. The opening is formed so as to extend in a longitudinal direction of the container. The reinforcing member is provided on a side opposite from the fixing portion with respect to the opening, and as seen in a direction perpendicular to a plane including the opening. The bonding portion and the reinforcing member at least partially overlap with each other.

### FIELD OF THE INVENTION AND RELATED ART

The present invention relates to a developer accommodating member, a developer accommodating unit, a developing device and a process cartridge which are to be used in an image forming apparatus.

Here, the image forming apparatus forms an image on a recording material by using, for example, an electrophotographic image forming process. For example, the image forming apparatus includes an electrophotographic copying machine, an electrophotographic printer (such as LED (light emitting diode) printer or laser beam printer), and an electrophotographic facsimile machine and the like.

Further, the cartridge refers to a cartridge which is constituted integrally with a developing device at least accommodating a developing means and the developer and which is made detachably mountable to an image forming apparatus main assembly or a cartridge which is constituted integrally with the developing device and a photosensitive member unit at least including a photosensitive member and which is made detachably mountable to the image forming apparatus main assembly.

Further, the developer accommodating member is to be accommodated in the image forming apparatus or the cartridge. The developer accommodating member includes at least a flexible container for accommodating the developer.

In a conventional electrophotographic image forming apparatus using the electrophotographic image forming process, a process cartridge type in which an electrophotographic photosensitive member and process means actable thereon are integrally assembled into a cartridge and the cartridge is made detachably mountable to an electrophotographic image forming apparatus main assembly has been employed.

In such a process cartridge, as shown in FIG. 39, a plurality of openings 35 provided in a developer accommodating container 34 for accommodating a developer (toner, carrier and the like) is sealed with a sealing member 19. Then, a bonding portion of the sealing member 19 is peeled off during use and thus the openings 35 are exposed, so that the developer can be supplied through the openings 35 (Japanese Laid-Open Patent Application (JP-A) 2013-37345).

However, as in JP-A 2013-37345, in a constitution in which the developer accommodating container 24 is provided with the plurality of openings 35, in the case where an inside developer is intended to be discharged in a large amount, discharge of the developer is prevented by connecting portions provided between the openings 35. For this reason, there was a need to device a measure so as to conform to a desired discharging property.

That is, it is desired that an developer accommodating container capable of improving a discharging property of a developer accommodated in a flexible container provided with a single opening.

### SUMMARY OF THE INVENTION

According to an aspect of the present invention, there is provided a developer accommodating member for accommodating a developer, comprising: a flexible container provided with a single opening for permitting discharge of the developer; a sealing member bonded to a periphery of the opening and configured to seal the opening; a bonding portion bonding the periphery of the opening and the sealing member; and a reinforcing member, wherein the container includes a fixing portion fixable in a neighborhood of the opening, wherein the opening is formed so as to extend in a longitudinal direction of the container, and wherein the reinforcing member is provided on a side opposite from the fixing portion with respect to the opening, and as seen in a direction perpendicular to a plane including the opening, the bonding portion and the reinforcing member at least partially overlap with each other.

Further features of the present invention will become apparent from the following description of exemplary embodiments with reference to the attached drawings.

### BRIEF DESCRIPTION OF THE DRAWINGS

FIG. 1 is a sectional view showing a structure of an image forming apparatus including a developer accommodating member according to First Embodiment of the present invention.

FIG. 2 is a sectional view showing a structure of a process cartridge including the developer accommodating member in First Embodiment.

FIG. 3 is a sectional view showing a structure of a developing device before an opening provided in the developer accommodating member in First Embodiment is unsealed.

FIG. 4 is a perspective view showing a state in which the opening provided in the developer accommodating member is unsealed by rotation of an unsealing member in First Embodiment.

Part (a) of FIG. 5 is a perspective view showing a structure of the developer accommodating member before the opening provided in the developer accommodating container in First Embodiment is unsealed and part (b) of FIG. 5 is a perspective view showing a state in which a reinforcing member and a second bonding portion overlap with each other.

Parts (a) and (b) of FIG. 6 are perspective views showing a structure of the developer accommodating member during unsealing of the opening provided in the developer accommodating container in First Embodiment.

Part (a) of FIG. 7 is a sectional view showing a structure of a developer accommodating member provided with a reinforcing member on an inner surface side of the developer accommodating container in First Embodiment, part (b) of FIG. 7 is partially enlarged view of part (a) of FIG. 7, part (c) of FIG. 7 is a partially enlarged view of the developer accommodating member provided with the reinforcing member at another position on the inner surface side of the developer accommodating container in First Embodiment, and (d) of FIG. 7 is a sectional view showing a structure of a developer accommodating member provided with a reinforcing member on an outer surface side of the developer accommodating container.

Part (a) to (c) of FIG. 8 are perspective views showing a state of filling (charging) a developer in the developer accommodating container.

Part (a) to (c) of FIG. 9 are partially sectional views showing a process of unsealing the opening provided in the developer accommodating container in First Embodiment.

Parts (a) and (b) of FIG. 10 are partially sectional views showing the process of unsealing the opening in the case where the reinforcing member is provided on the inner surface side of the developer accommodating container in First Embodiment.

FIG. 11 is a sectional view showing a structure of the developing device after the opening provided in the developer accommodating container in First Embodiment is unsealed.

FIG. 12 is a sectional view showing a structure of the developing device in First Embodiment.

FIG. 13 is a sectional view showing a structure of the developing device in First Embodiment.

FIG. 14 is a sectional view showing a structure in the neighborhood of the opening of the developer accommodating member in First Embodiment.

FIG. 15 is a sectional view showing a structure of the developing device immediately before the opening provided in the developer accommodating container in First Embodiment is unsealed.

FIG. 16 is a sectional view showing a structure of the developing device during the unsealing of the opening provided in the developer accommodating container in First Embodiment.

Parts (a) and (b) of FIG. 17 are perspective views showing a structure of a developer accommodating member during unsealing of an opening provided in a developer accommodating container in a comparison example in which it is difficult to unseal the opening.

FIG. 18 is a sectional view showing a structure of a developing device in the comparison example in which it is difficult to unseal the opening.

Parts (a) to (c) of FIG. 19 are partially sectional views showing a process of unsealing the opening provided in the developer accommodating container in the comparison example in which it is difficult to unseal the opening.

Part (a) of FIG. 20 is a sectional view showing a structure of a developer accommodating member provided with a reinforcing member on an inner surface side of a developer accommodating container, part (b) of FIG. 20 is a partially enlarged view of part (a) of FIG. 20, and part (c) of FIG. 20 is a partially sectional view showing a structure of a peripheral portion of an opening provided in the developer accommodating container.

FIG. 21 is a perspective view for illustrating a length of the reinforcing member with respect to a longitudinal direction in First Embodiment.

Part (a) of FIG. 22 is a perspective view showing a structure of a developer accommodating member provided with another reinforcing member in First Embodiment, and parts (b) to (e) are perspective views showing various other reinforcing members in First Embodiment.

Part (a) of FIG. 23 is a sectional view showing a structure of the developer accommodating member provided with another reinforcing member in First Embodiment on an inner surface side of a developer accommodating container, and (b) of FIG. 23 is a sectional view showing a structure of a developer accommodating member provided with another reinforcing member in First Embodiment on an outer surface side of a developer accommodating container.

Parts (a) and (b) of FIG. 24 are sectional views for illustrating the comparison example in which the developer accommodating container is not provided in the developer accommodating container, parts (c) and (d) are sectional views showing a state in which the reinforcing member is provided on the inner surface side of the developer accommodating container in First Embodiment, and parts (e) and (f) are sectional views showing a state in which another reinforcing member is provided on the inner surface side of the developer accommodating container.

Part (a) of FIG. 25 is a sectional view showing motion of a peripheral portion of the opening with rotation of an urging member in the comparison example in which the reinforcing member is not provided in the developer accommodating container, part (b) of FIG. 25 is a sectional view showing motion of a peripheral portion of the opening with rotation of an urging member in the case where the reinforcing member is provided on the inner surface side of the developer accommodating container in First Embodiment, and part (c) of FIG. 25 is a sectional view showing motion of a peripheral portion of the opening with rotation of an urging member in the case where another reinforcing member is provided on the inner surface side of the developer accommodating container.

Part (a) of FIG. 26 is a perspective view showing a structure of a developer accommodating member provided with reinforcing members in Second Embodiment, part (b) of FIG. 26 is a perspective view showing a structure of the reinforcing member of part (a) of FIG. 26, and part (c) of FIG. 26 is a perspective view showing a structure of a developer accommodating member provided with a single reinforcing member shown in part (b) of FIG. 26.

Part (a) of FIG. 27 is a sectional view showing a structure of the developer accommodating container provided with the reinforcing member in Second Embodiment on an inner surface side of the developer accommodating container, and (b) of FIG. 27 is a sectional view showing a structure of the developer accommodating container provided with another reinforcing member in Second Embodiment on an outer surface side of the developer accommodating container.

FIG. 28 is a perspective view showing a structure of a developer accommodating member in Third Embodiment.

FIG. 29 is a partially sectional view showing a structure of a peripheral portion of an opening of a developer accommodating container in Third Embodiment.

Parts (a) and (b) of FIG. 30 are partially sectional views showing a process of unsealing the opening provided in the developer accommodating container in Third Embodiment.

Parts (a) and (b) of FIG. 31 are partially sectional views showing the process of unsealing the opening provided in the developer accommodating container in Third Embodiment.

FIG. 32 is a perspective view showing a structure of another developer accommodating container in Third Embodiment in which strength of a reinforcing portion is enhanced.

FIG. 33 is a perspective view showing a structure of still another developer accommodating container in Third Embodiment in which a reinforcing portion is provided with an adhesive.

FIG. 34 is a sectional view showing a structure of a further developer accommodating member in Third Embodiment in which a state that a reinforcing portion is bonded to an inner wall surface of a frame of a developing device with an adhesive is formed.

FIG. 35 is a perspective view showing a state that a sealing member of a developer accommodating member in Fourth Embodiment is peeled off

FIG. 36 is sectional view showing a structure of a developing device including the developer accommodating member in Fourth Embodiment.

FIG. 37 is a perspective view showing a state immediately before the sealing member of the developer accommodating member in Fourth Embodiment is unsealed.

Parts (a) and (b) of FIG. 38 are perspective views showing a state of winding-up the sealing member by rotating an unsealing member of the developer accommodating member in Fourth Embodiment.

FIG. 39 is a perspective view showing a structure of a developer accommodating member in in the comparison example.

### DESCRIPTION OF THE PREFERRED EMBODIMENTS

An embodiment of a developer accommodating unit including a developer accommodating member according to the present invention, a developing device, a process cartridge and an image forming apparatus will be specifically described with reference to the drawings.

Incidentally, a developer accommodating member 37 described in the following embodiments includes a developer accommodating container 34 comprising a flexible container which accommodates at least a developer and which is provided with a single opening 35 for permitting discharge of the accommodated developer. The developer accommodating member 37 further includes a sealing member 19 for sealing the opening 35, provided in the developer accommodating container 34, for discharging the developer.

A developer accommodating unit 25 includes at least the developer accommodating member 37, frames 17 and 18 for accommodating the developer accommodating member 37, and an unsealing member for peeling off a sealing member 19 from a bonding portion 22 provided at a periphery of the opening 35 by moving the sealing member 19. A developing device 38 includes at least the developer accommodating member 37 or the developer accommodating unit 25, and a developing roller 13 which is a developer carrying member for carrying the developer.

A process cartridge A includes at least the developer accommodating member 37, or the developer accommodating unit 25 or the developing device 38, and a photosensitive drum 11 which is an image bearing member for bearing an electrostatic latent image. An image forming apparatus B includes at least the developer accommodating member 37, or the developer accommodating unit 25, or the developing device 38 or the process cartridge A, and an image forming means for forming an image on a recording material S.

### First Embodiment

Structures of the developer accommodating unit 25 including the developer accommodating member 37 according to the present invention, and of the developing device 38, the process cartridge A and the image forming apparatus B in First Embodiment will be described.

### <Image Forming Apparatus>

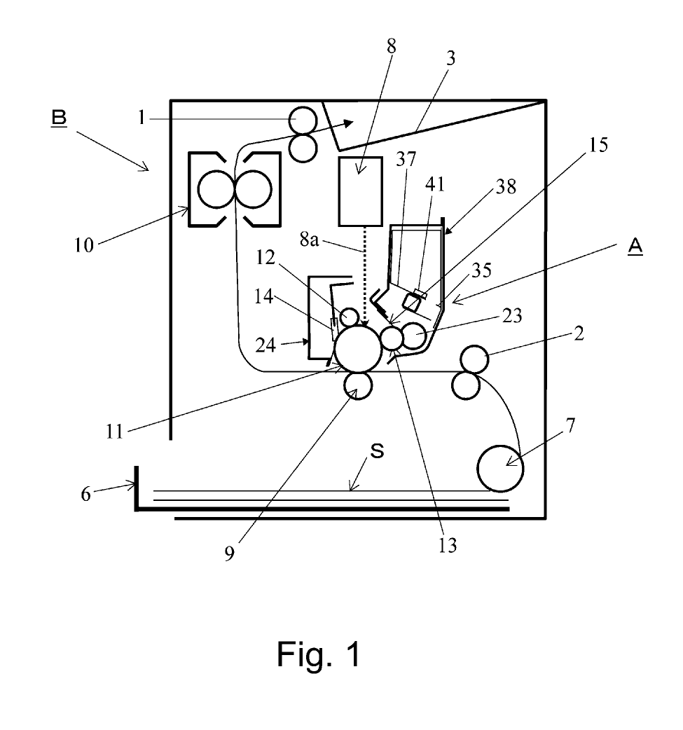

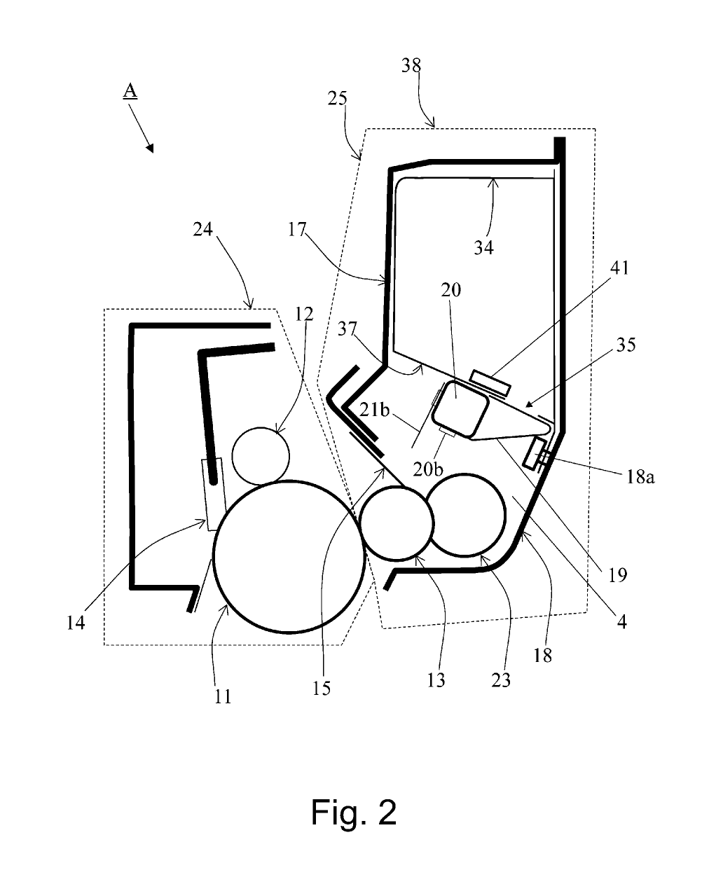

The structure of the image forming apparatus B will be described using FIGS. 1 and 2. FIG. 1 is a sectional view showing the structure of the image forming apparatus B including the developer accommodating member 37 in this embodiment. FIG. 2 is a sectional view showing the structure of the process cartridge A including the developer accommodating member in this embodiment.

The image forming apparatus B shown in FIG. 1 is used for image formation after the process cartridge A shown in FIG. 2 is mounted therein. In the image forming apparatus B shown in FIG. 1, the recording materials S accommodated in a feeding cassette 6 are fed by a feeding roller 7. Thereafter, the recording materials S are separated and fed one by one by an unshown separating means, and a leading end portion of the fed recording material S is abutted against a nip of a registration roller pair 2 being at rest, so that oblique movement of the recording material S is corrected.

On the other hand, the photosensitive drum 11 which is the image bearing member for bearing the electrophotographic latent image is rotationally driven in the clockwise direction in FIG. 1, and a surface of the photosensitive drum 11 is uniformly charged by a charging roller 12 which is a charging means. The uniformly charged surface of the photosensitive drum 11 is selectively exposed to light 8a depending on image information by an exposure device 8 which is an exposure means, so that the electrostatic latent image is formed.

To the electrostatic latent image formed on the surface of the photosensitive drum 11, a developer is supplied by the developing device 38 which is is developing means. The developer in the developing device 38 is supplied to the developing roller 13 which is a developer carrying member by a sponge-shaped supplying roller 23, and is carried in a thin layer on a surface of the developing roller 13 by a developing blade 15.

From an unshown developing bias voltage source to the developing roller 13, a developing bias is applied, so that the developer is supplied to the electrostatic latent image formed on the surface of the photosensitive drum 11 and thus the electrostatic latent image is developed into a toner image on the surface of the photosensitive drum 11. In synchronism with rotation of the photosensitive drum 11 on which the toner image is formed at the surface thereof, the recording material S is nipped and fed by the registration roller pair 2.

From an unshown transfer bias voltage source to a transfer roller 9 which is a transfer means, a transfer bias voltage is applied. As a result, the toner image formed on the surface of the photosensitive drum 11 is transferred onto a surface of the recording material S. The recording material S on which the toner image is transferred is fed to a fixing device 10 which is a fixing means and is heated and pressed during nip-feeding by a heating roller and a pressing roller which are provided in the fixing device 10, so that the toner image is fixed. The recording material S on which the toner image is fixed is nipped and fed by a discharging roller pair 11 and is discharged onto a discharging tray 3.

### <Press Cartridge>

A structure of the process cartridge A will be described using FIG. 2. The process cartridge A shown in FIG. 2 includes the photosensitive drum 11 and an image forming process means actable on the surface of the photosensitive drum 11. The image forming process means includes the charging roller 12 for electrically charging the surface of the photosensitive drum 11 uniformly and the developing device 38 for developing the electrostatic latent image into the toner image on the surface of the photosensitive drum 11.

Further, the process cartridge A includes a cleaner unit 24 which is a cleaning means for removing the developer (containing toner, a carrier and the like) remaining on the surface of the photosensitive drum 11 after the transfer. The cleaning unit 24 is provided with an elastic cleaning blade 14. The process cartridge A in this embodiment integrally includes the cleaner unit 24 and the developing device 38 and is constituted so as to be detachably mountable to a main assembly of the image forming apparatus B.

### <Developing Device>

The developing device 38 includes frames 17 and 18 covering an outer periphery of the developer accommodating container 34 comprising a flexible container. The developing device 38 further includes the developing roller 13 which is the developer carrying member and a developing blade 15 which is a developer regulating means for regulating a layer thickness of the developer carried on the surface of the developing roller 13, a developer supplying roller 23 for supplying the developer to the developing roller 13, and the developer accommodating member 37 for accommodating the developer. The developing roller 13 and the developing blade 15 are supported by the frame 17.

### <Developer Accommodating Unit>

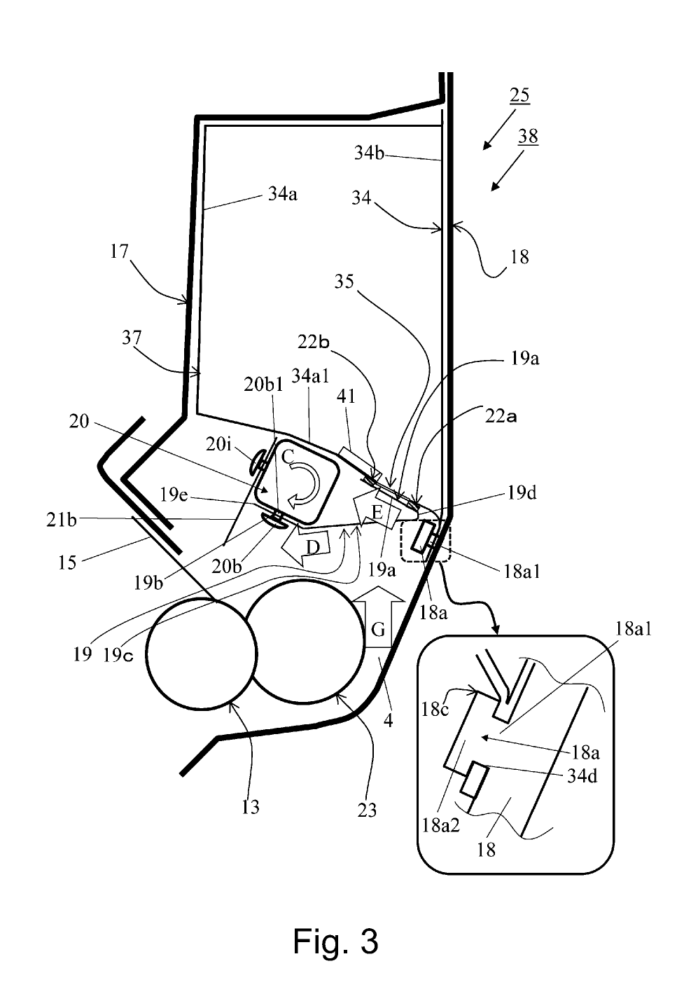

A structure of the developer accommodating unit 25 will be described using FIG. 3. FIG. 2 is a sectional view showing a structure of the developing device 38 before an opening 35 provided in the developer accommodating container 34 in this embodiment is unsealed. As shown in FIG. 3, the developer accommodating unit 25 is constituted by including the developer accommodating member 37, an unsealing member 20 and the frames 17 and 18 for supporting these members. By the frames 17 and 18, a frame accommodating the developer accommodating member 37 is constituted.

### <Developer Accommodating Member>

A structure of the developer accommodating member 37 will be described using FIGS. 3 to 8. FIG. 3 is a perspective view showing a state in which the opening 35 provided in the developer accommodating container 34 is unsealed by rotation of the unsealing member 20 in this embodiment. Part (a) of FIG. 5 is a perspective view showing a structure of the developer accommodating member 37 before the opening 35 provided in the developer accommodating container 34 is unsealed. Part (b) of FIG. 5 is a perspective view showing a state in which a reinforcing member 41 and a second bonding portion 22b overlaps with each other.

Parts (a) and (b) of FIG. 6 are perspective views showing a structure of the developer accommodating member 37 during unsealing of the opening 35 provided in the developer accommodating container 34 in this embodiment. Part (a) of FIG. 7 is a sectional view showing a structure of the developer accommodating member 37 provided with the reinforcing member 41 on an inner surface side of the developer accommodating container 34 in this embodiment. Part (b) of FIG. 7 is a partially enlarged view of part (a) of FIG. 7. Part (c) of FIG. 7 is a partially enlarged view of the developer accommodating member 37 provided with the reinforcing member 41 at another position on the inner surface side of the developer accommodating container 34 in this embodiment. Part (d) of FIG. 7 is a sectional view showing a structure of the developer accommodating member 37 provided with the reinforcing member 41 on an outer surface side of the developer accommodating container 34. Parts (a) to (c) of FIG. 8 are perspective views showing a state of filling (charging) the developer in the developer accommodating container 34.

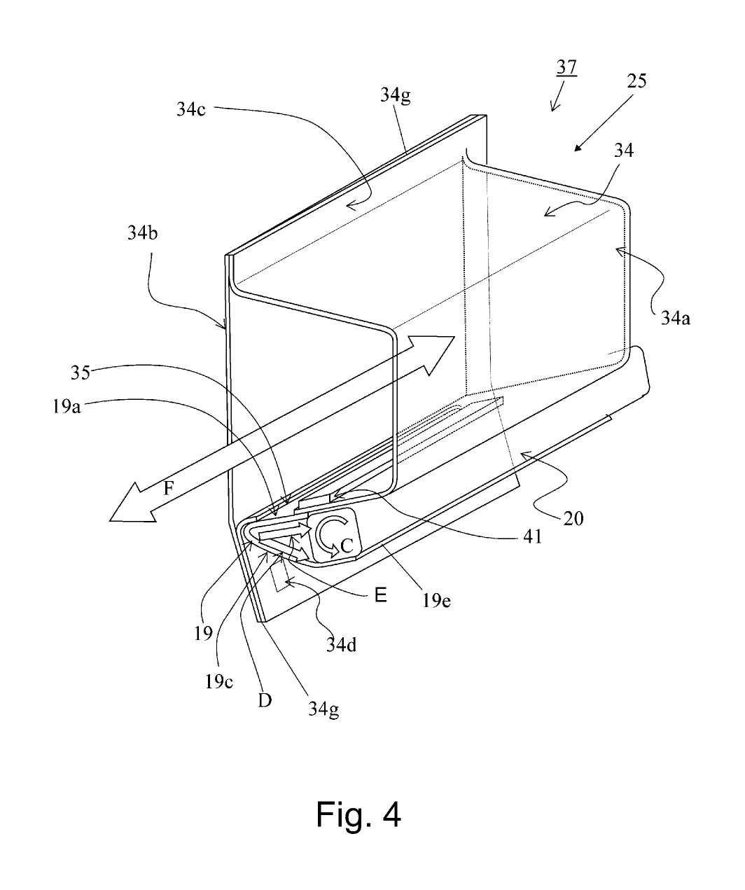

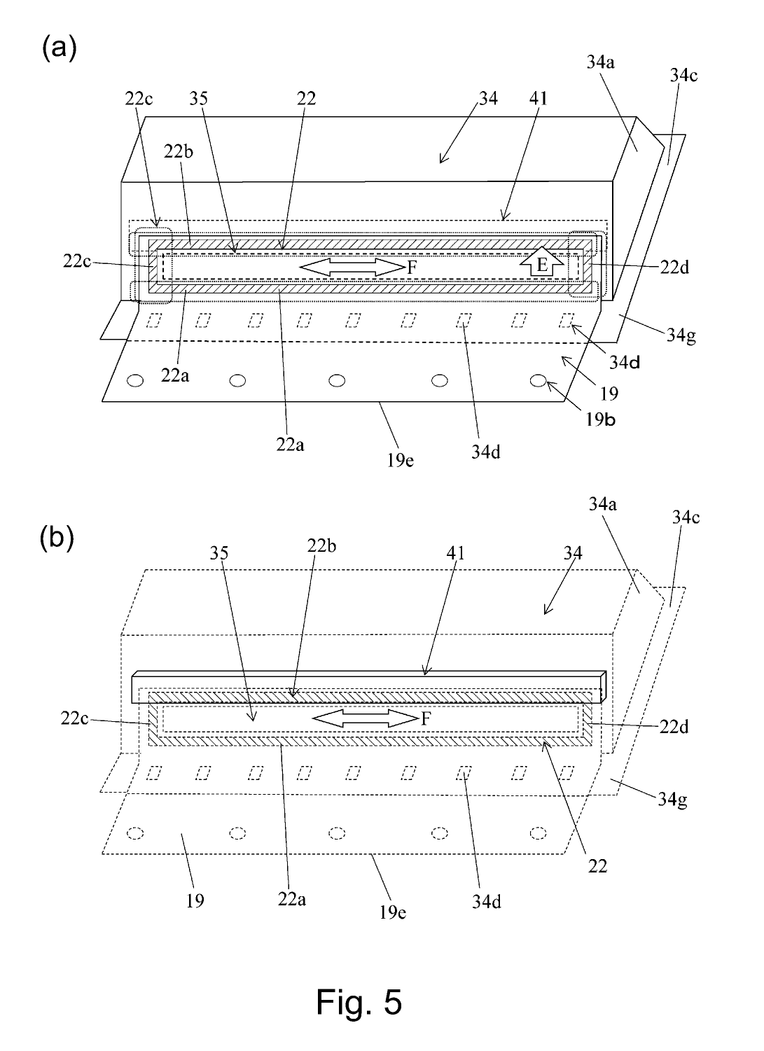

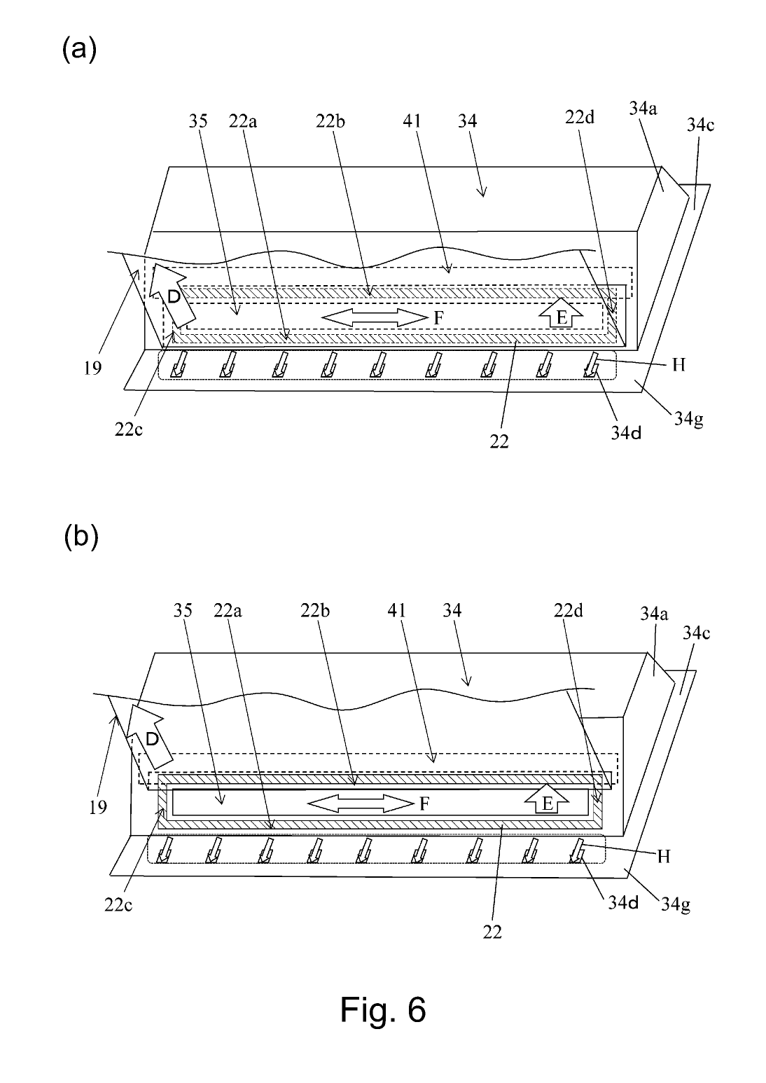

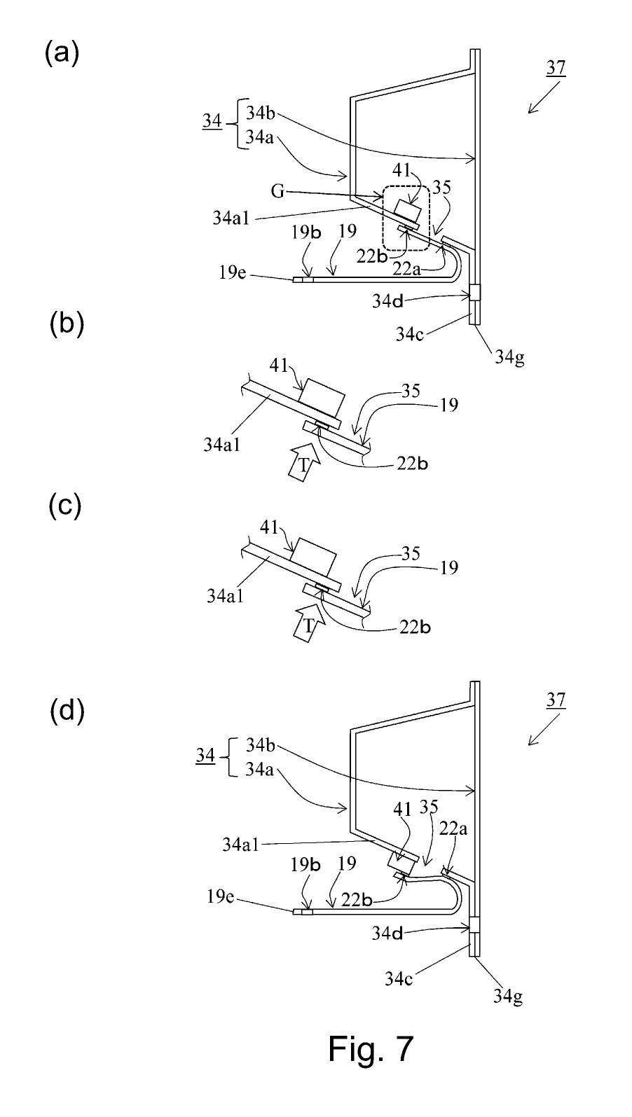

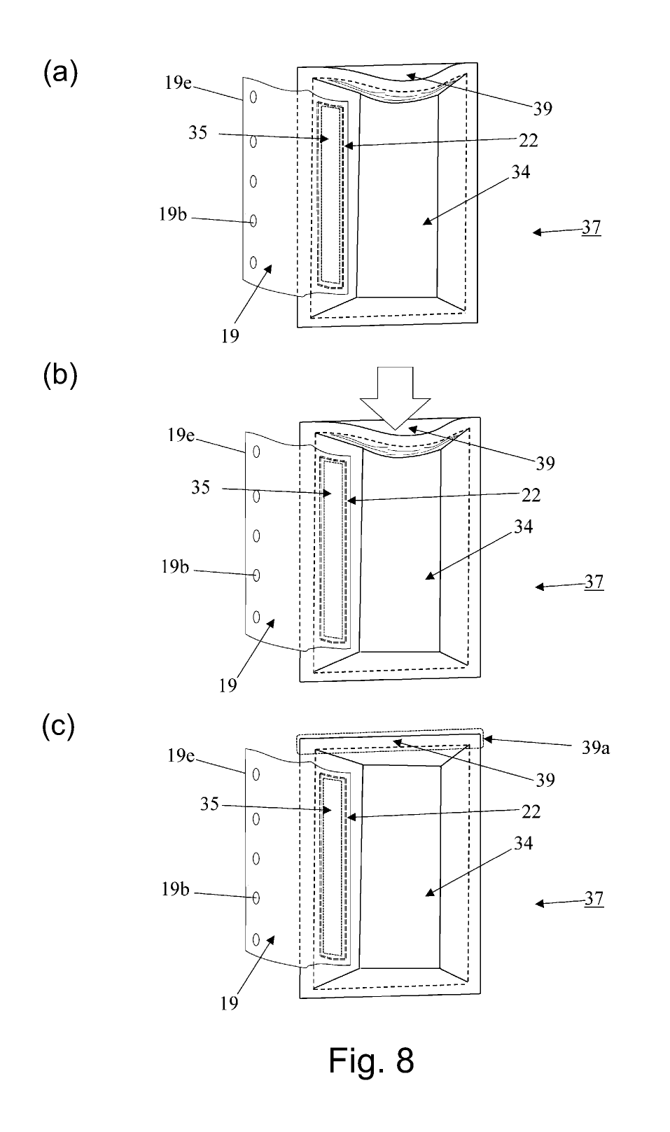

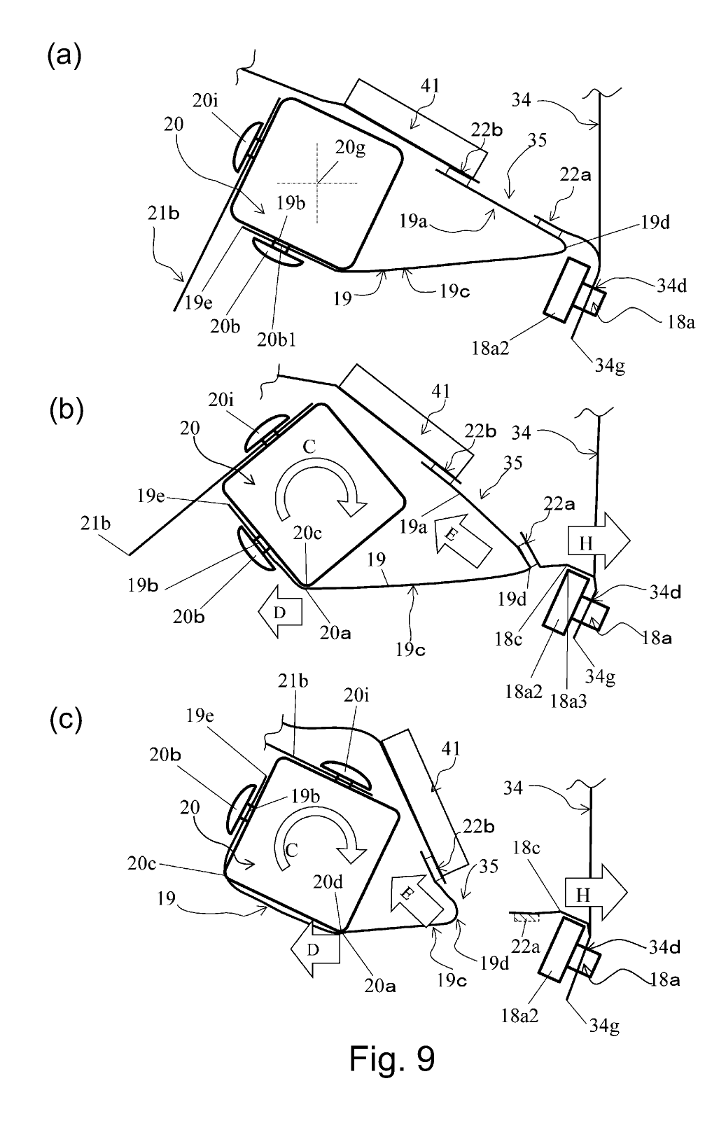

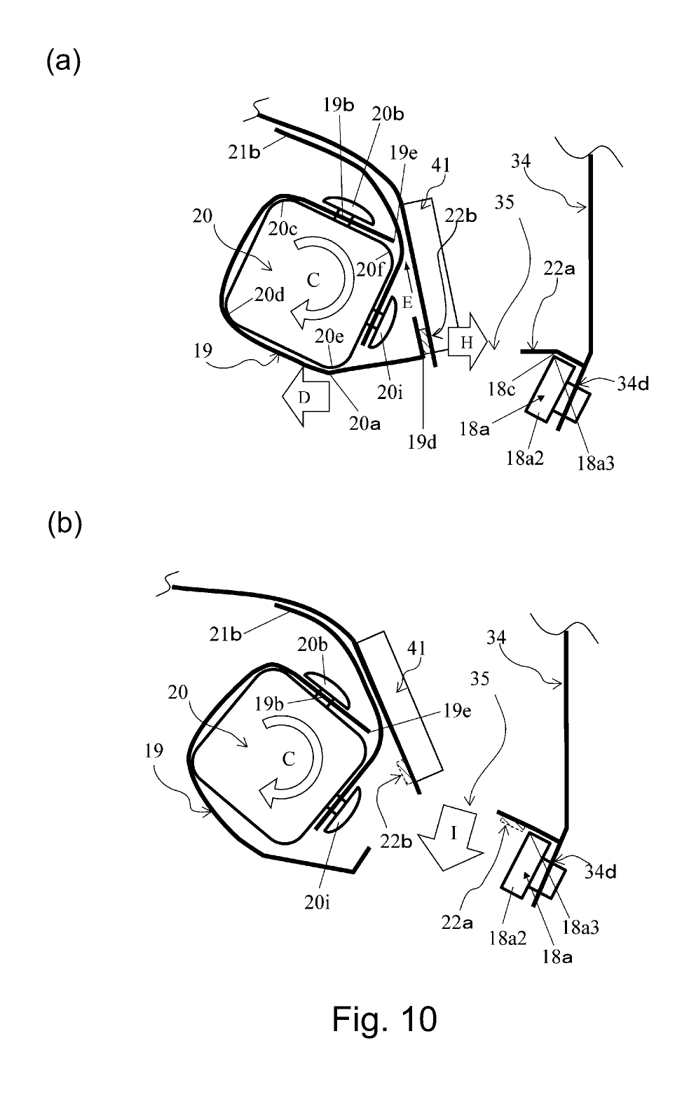

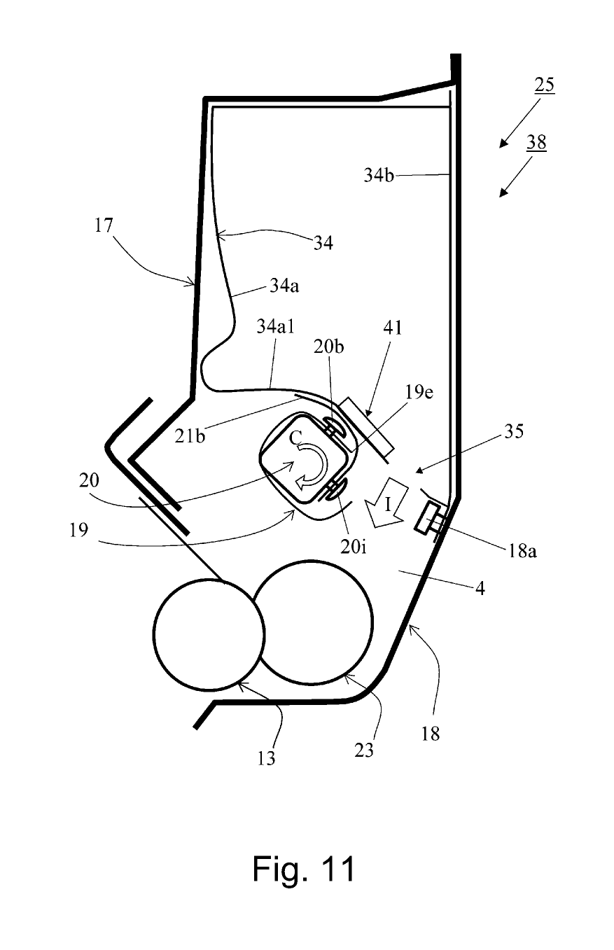

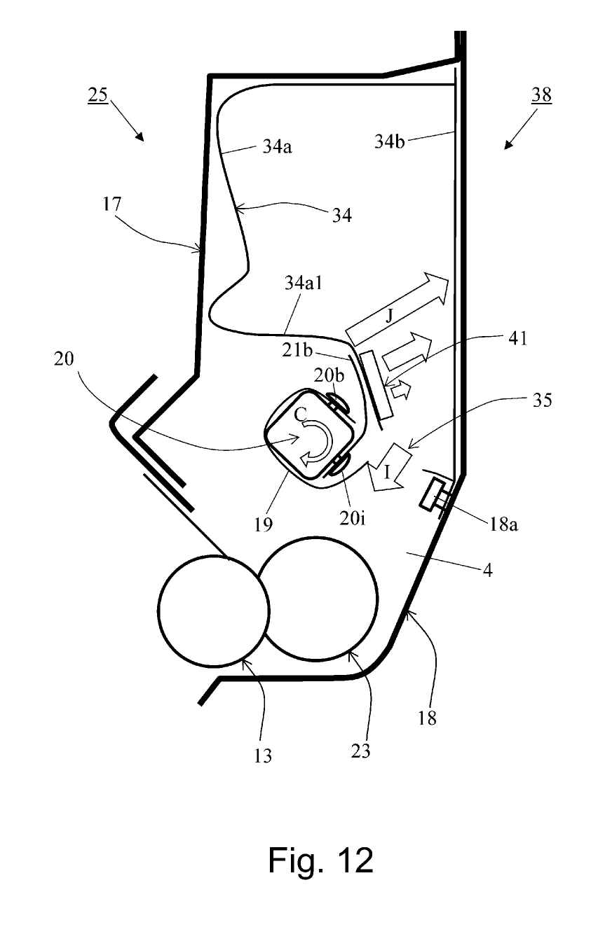

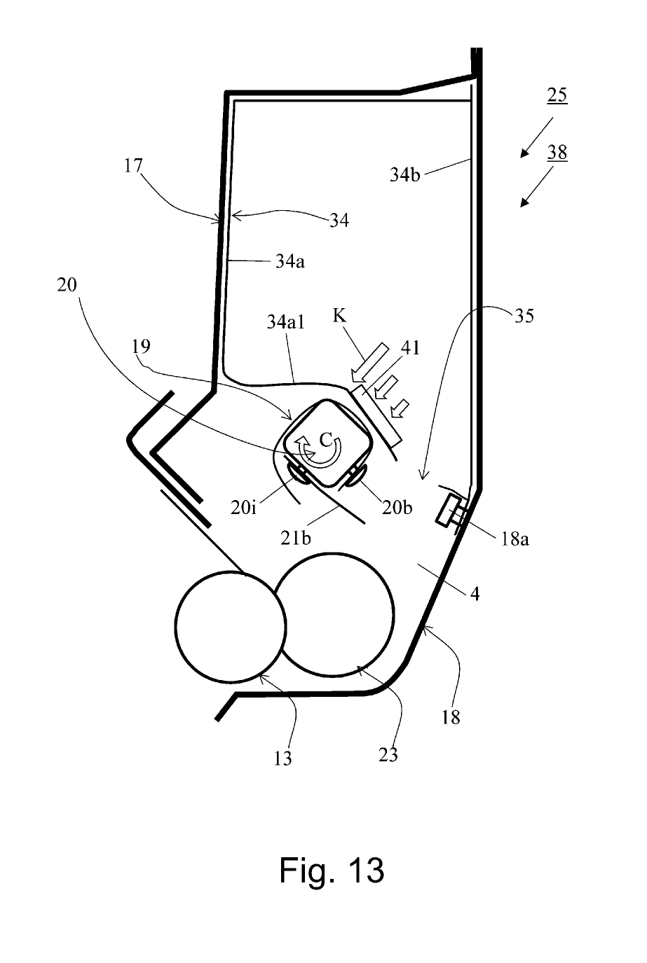

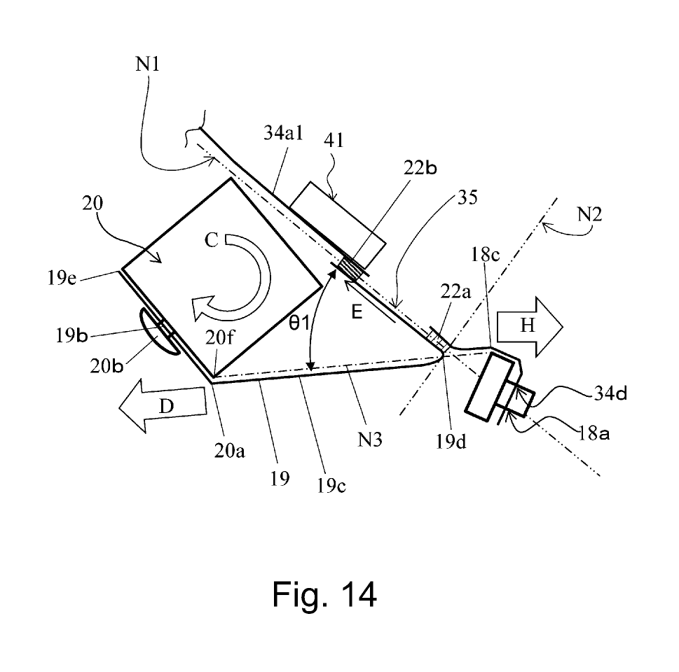

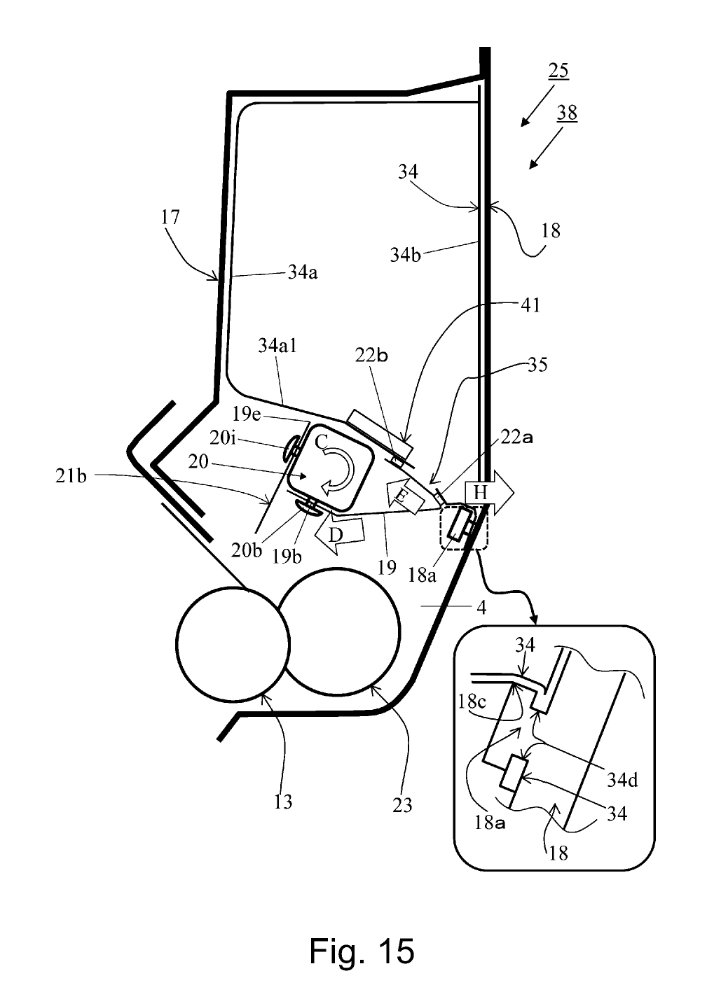

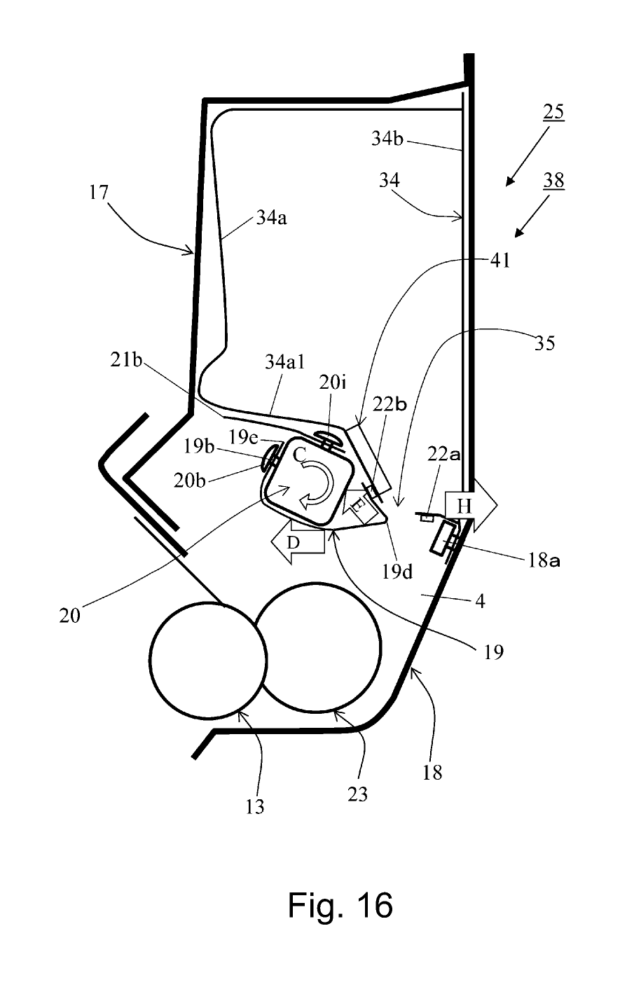

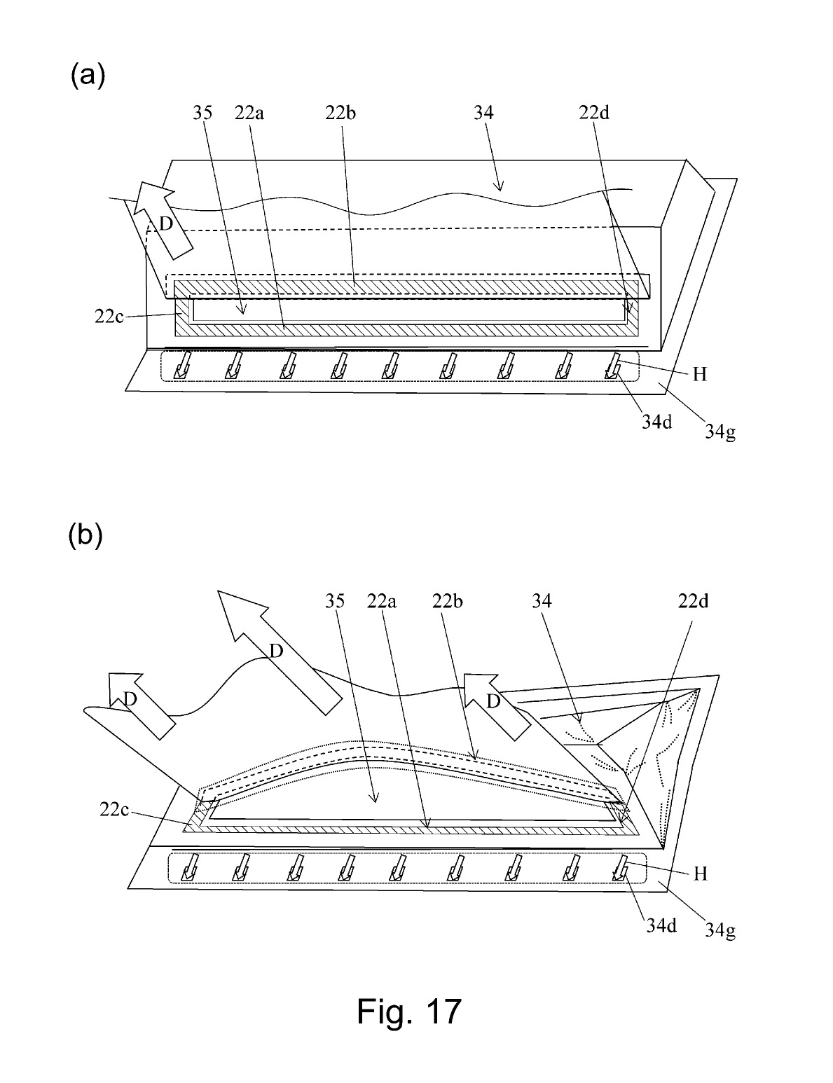

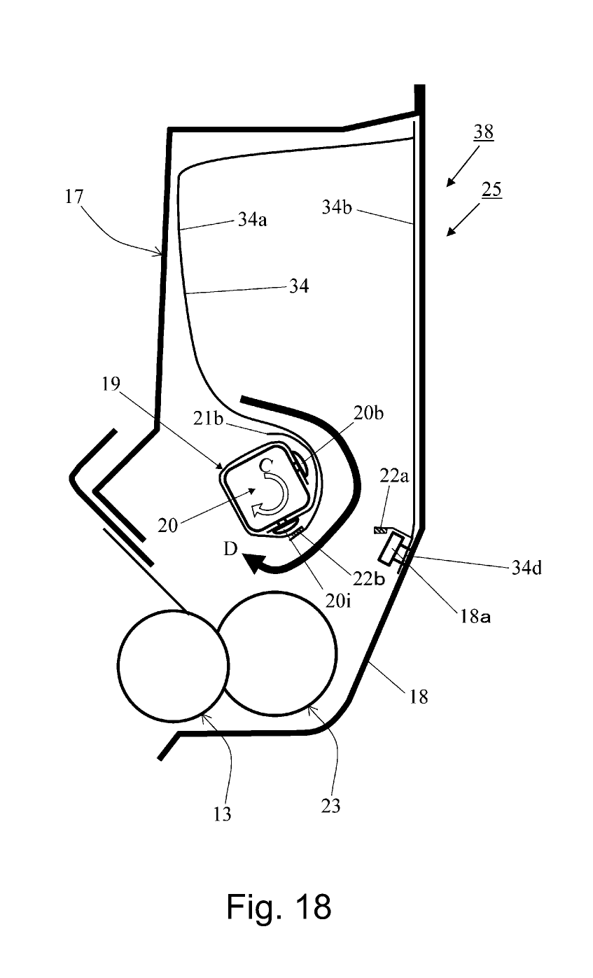

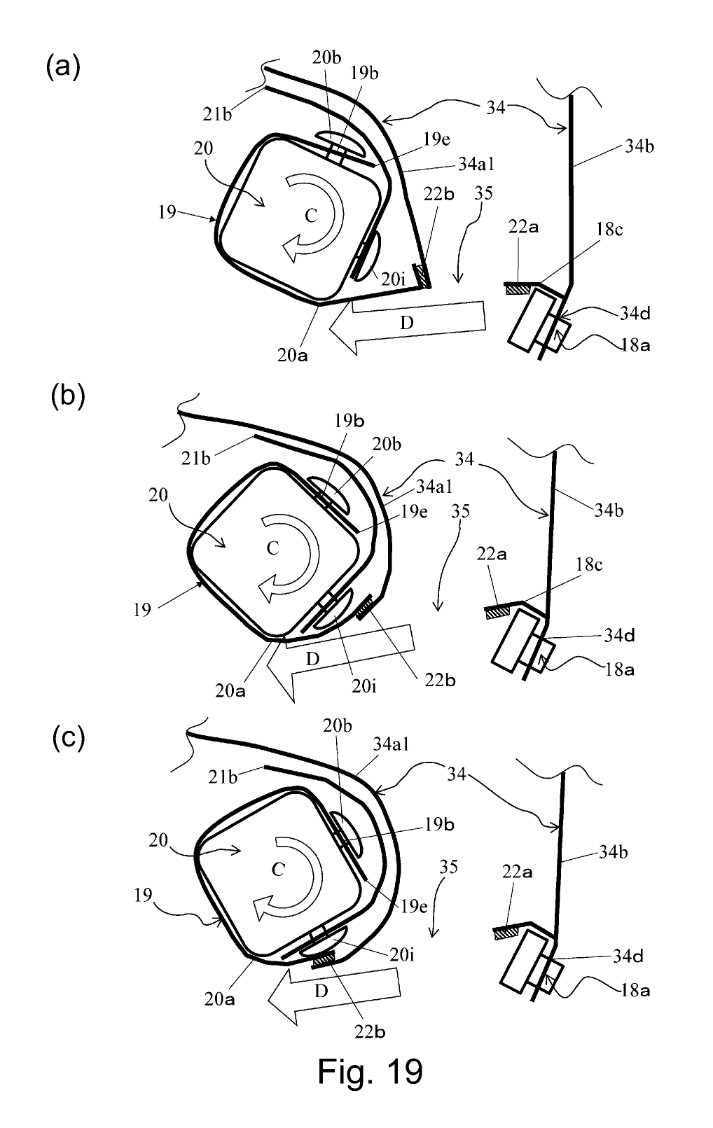

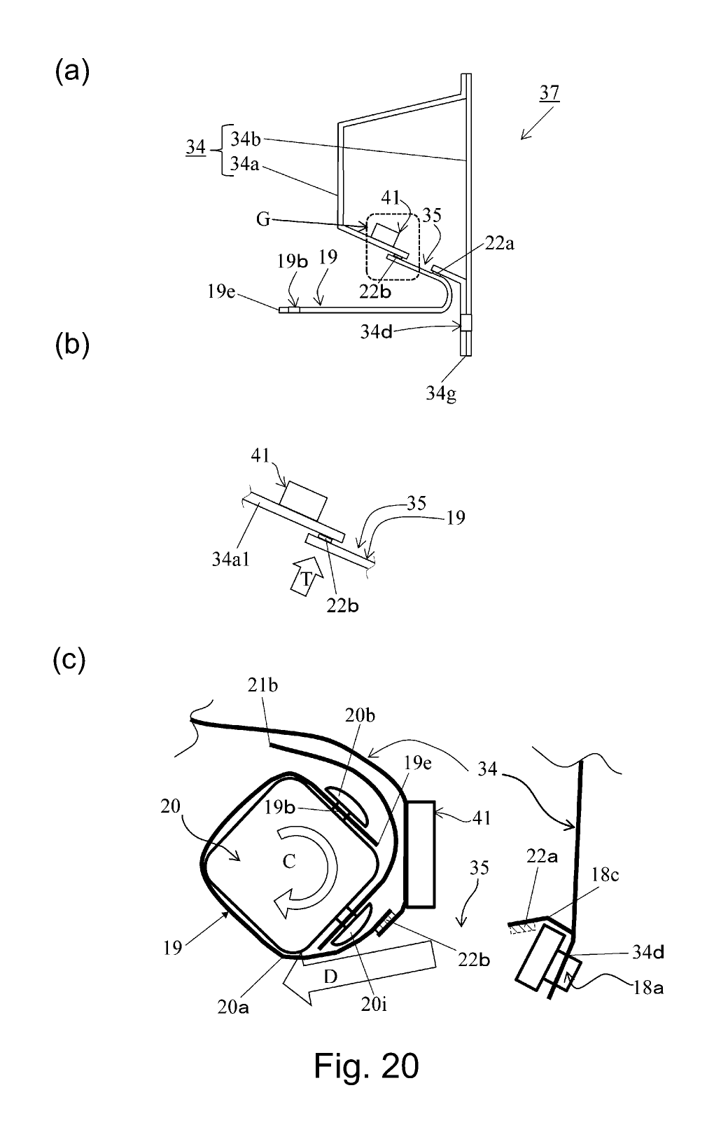

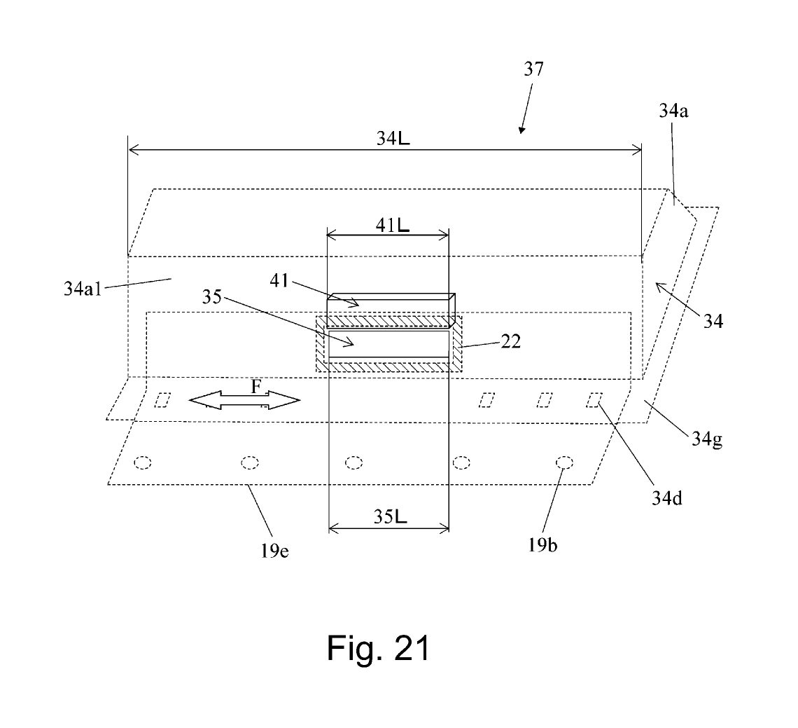

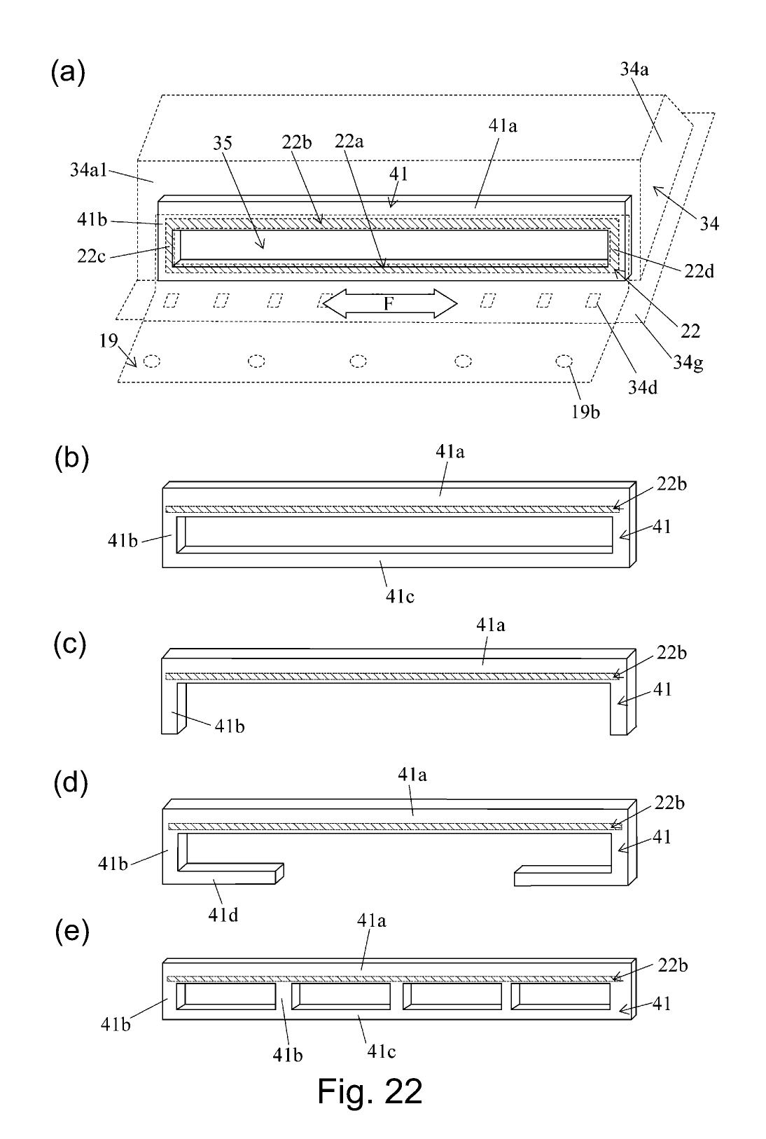

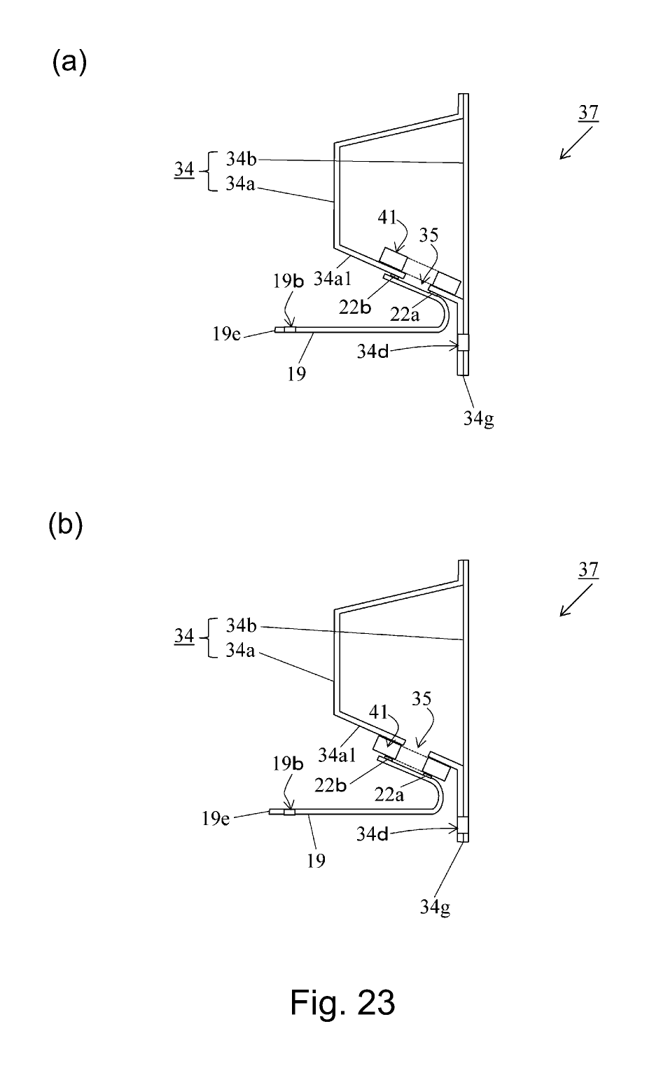

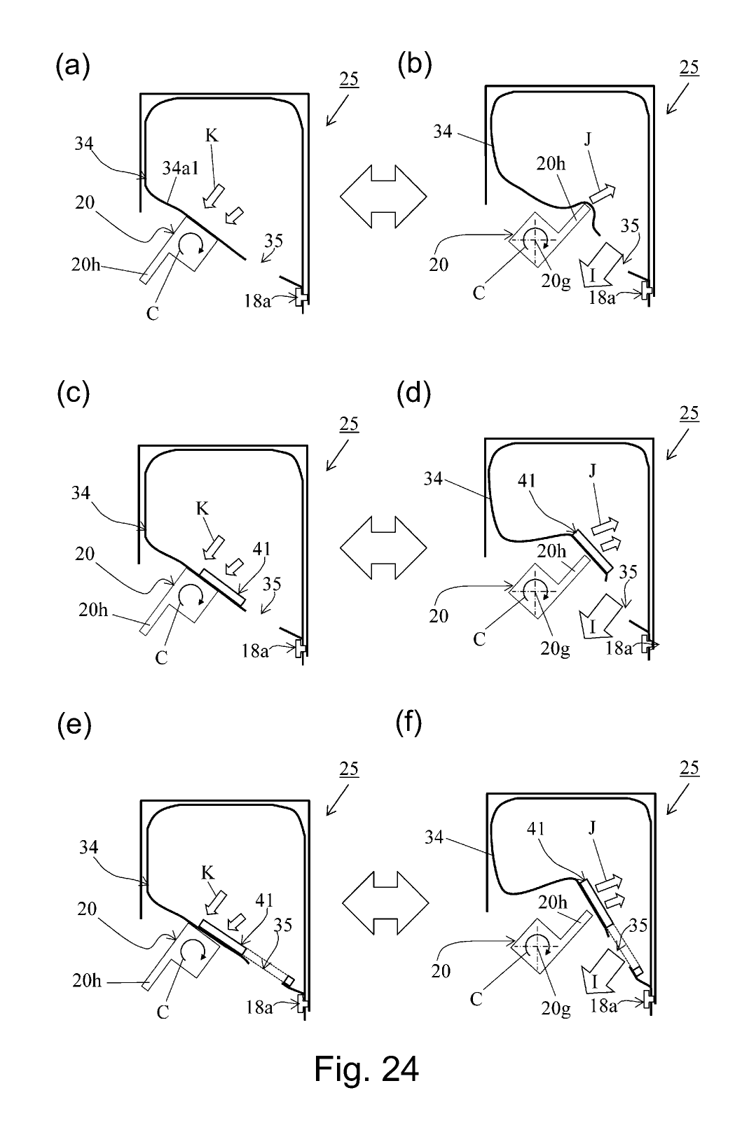

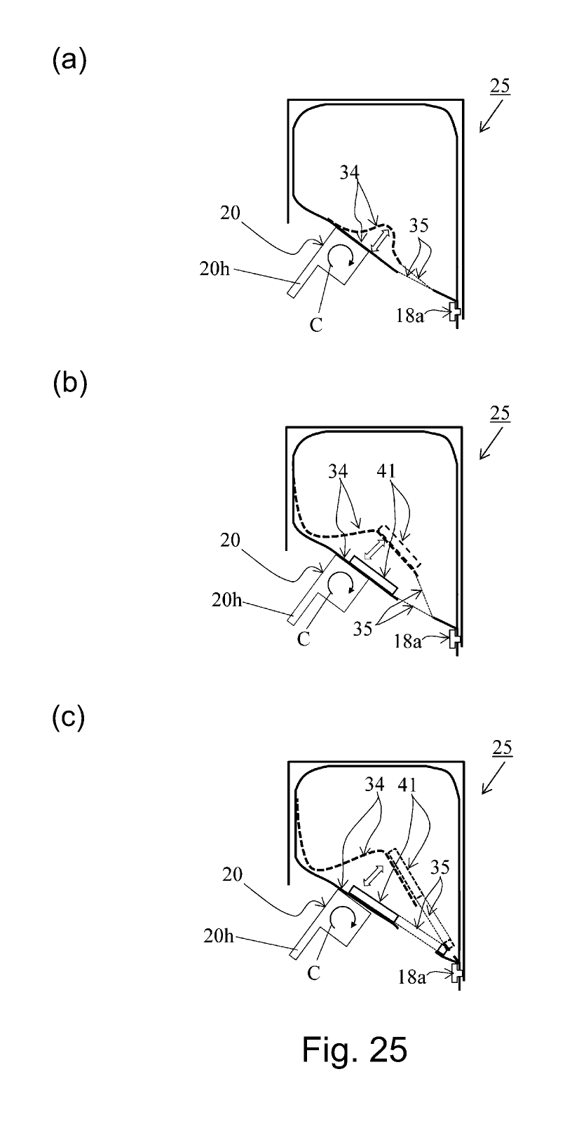

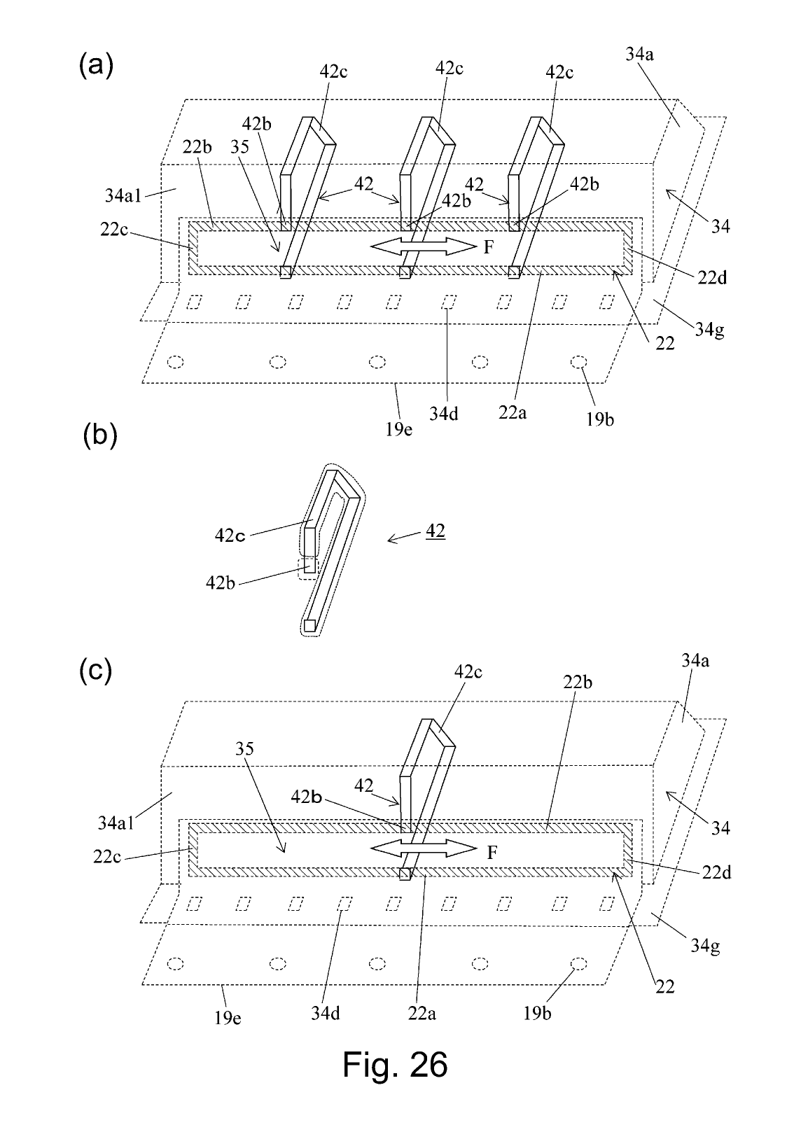

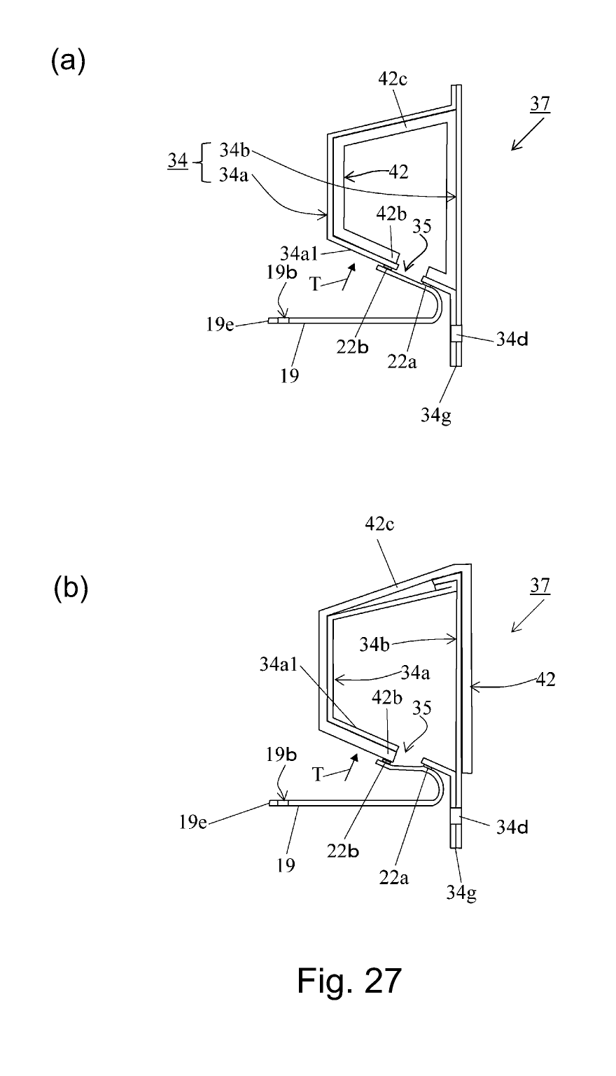

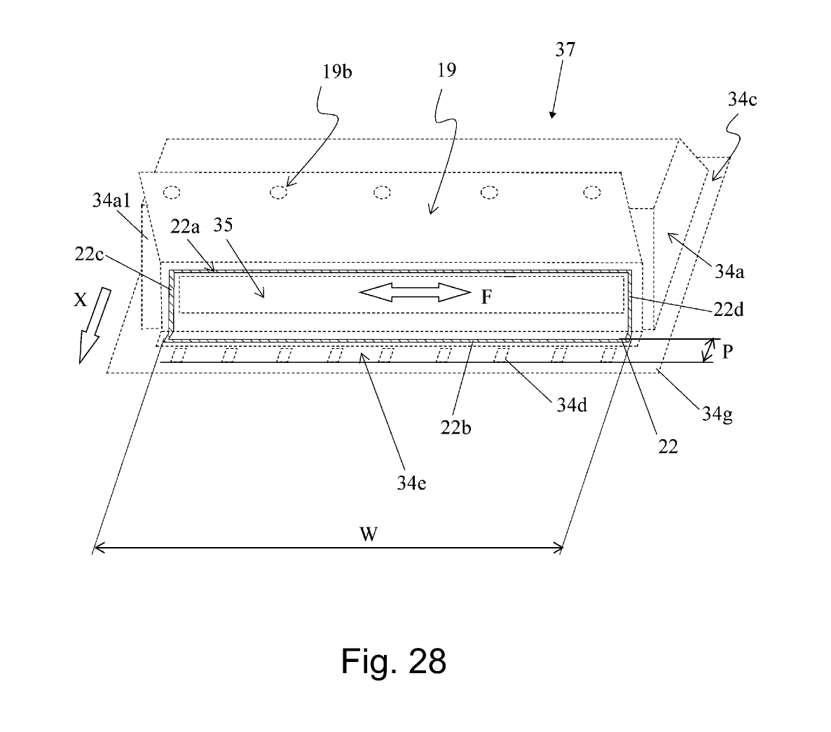

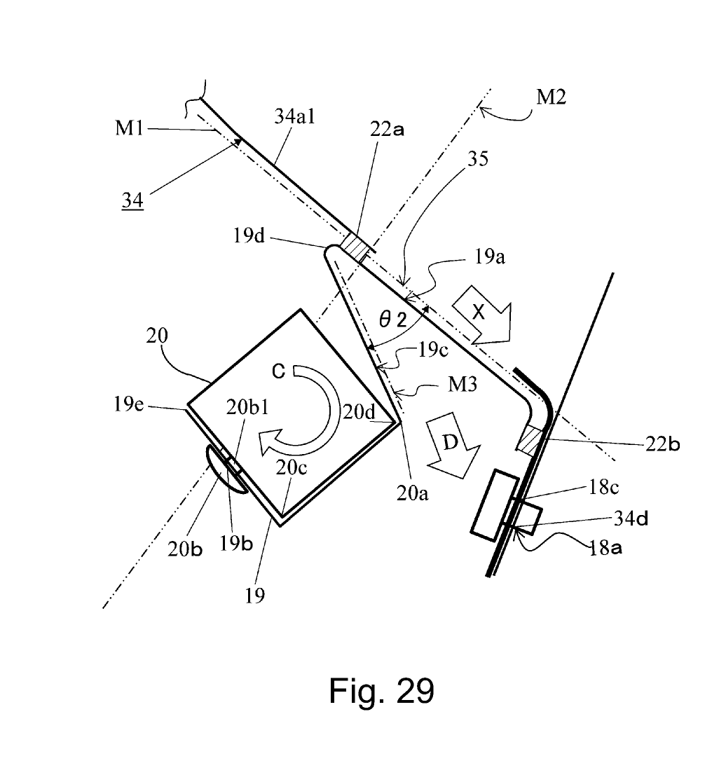

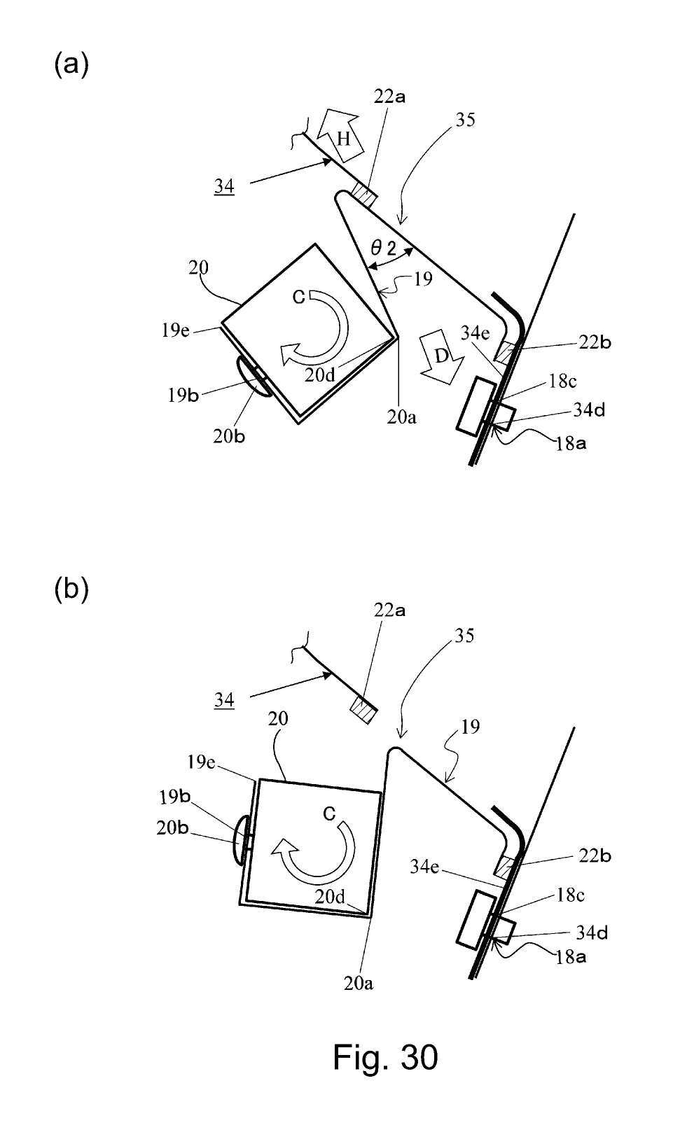

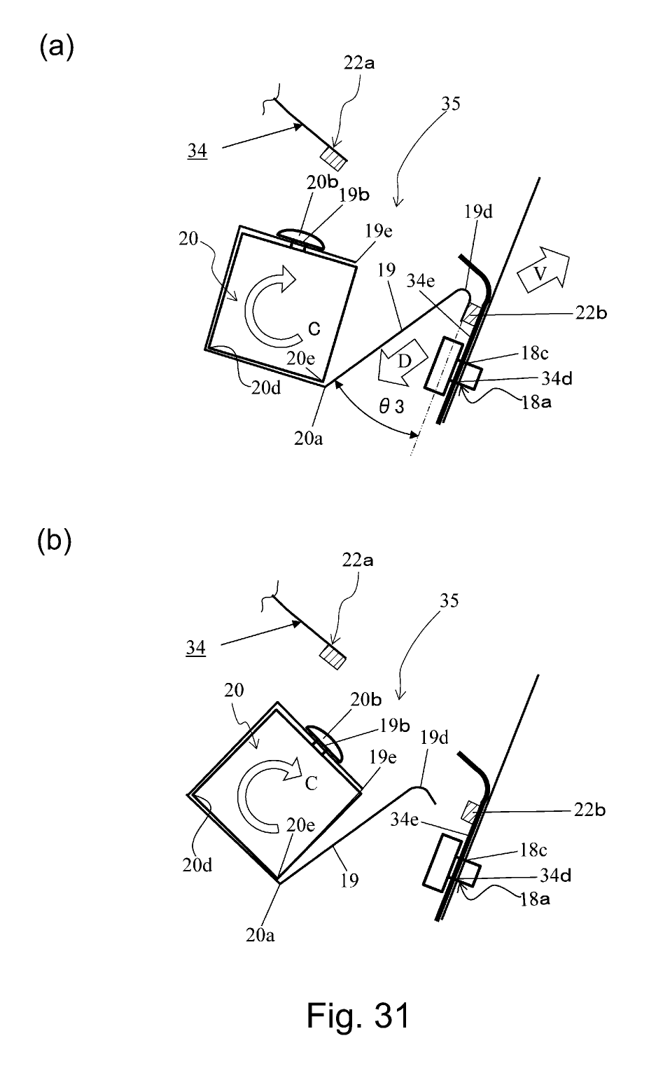

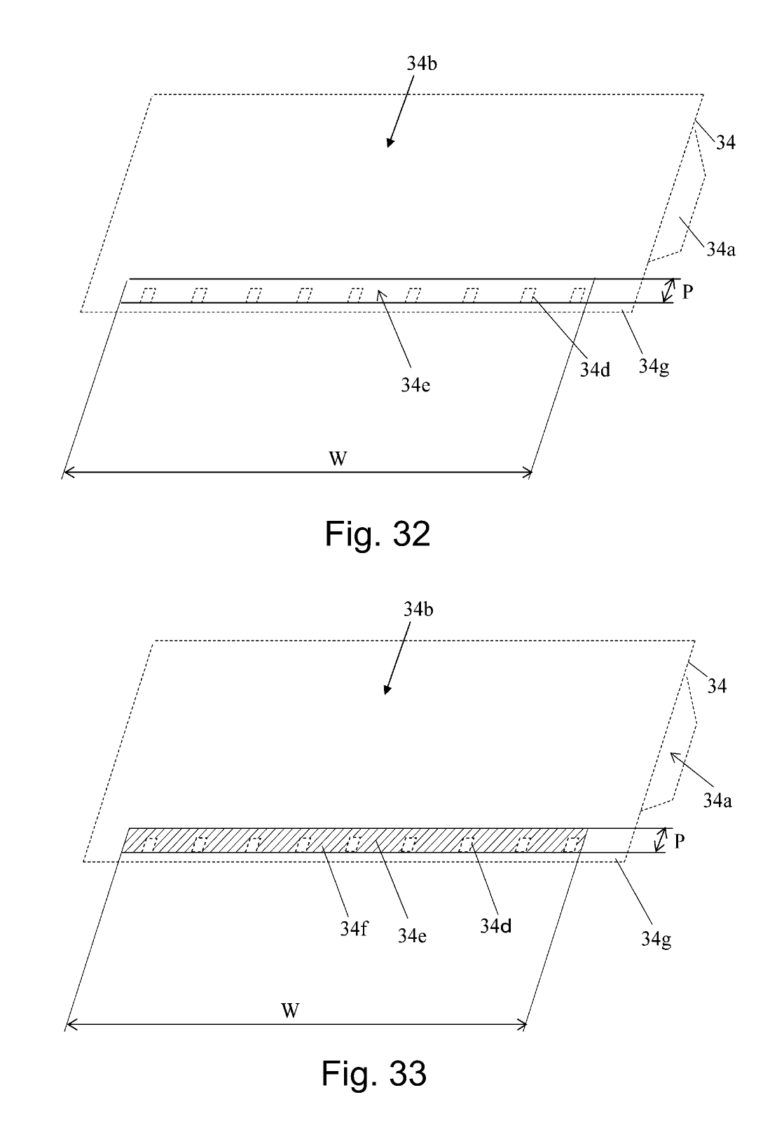

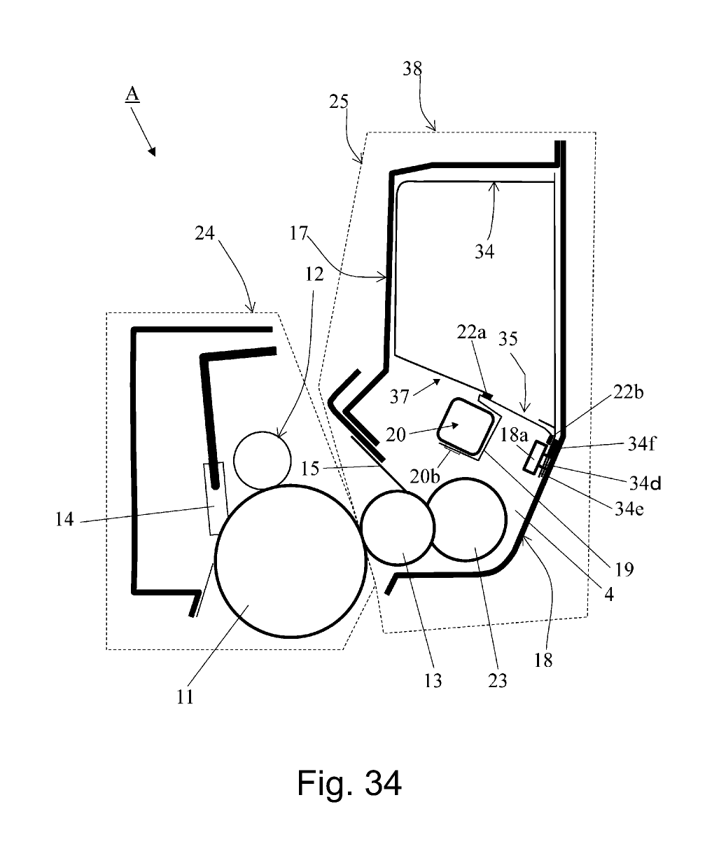

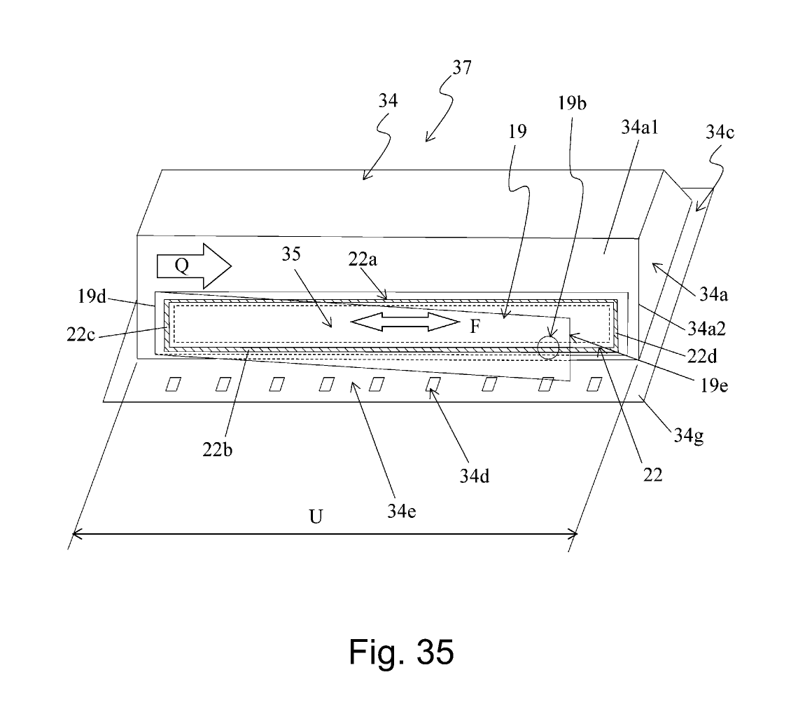

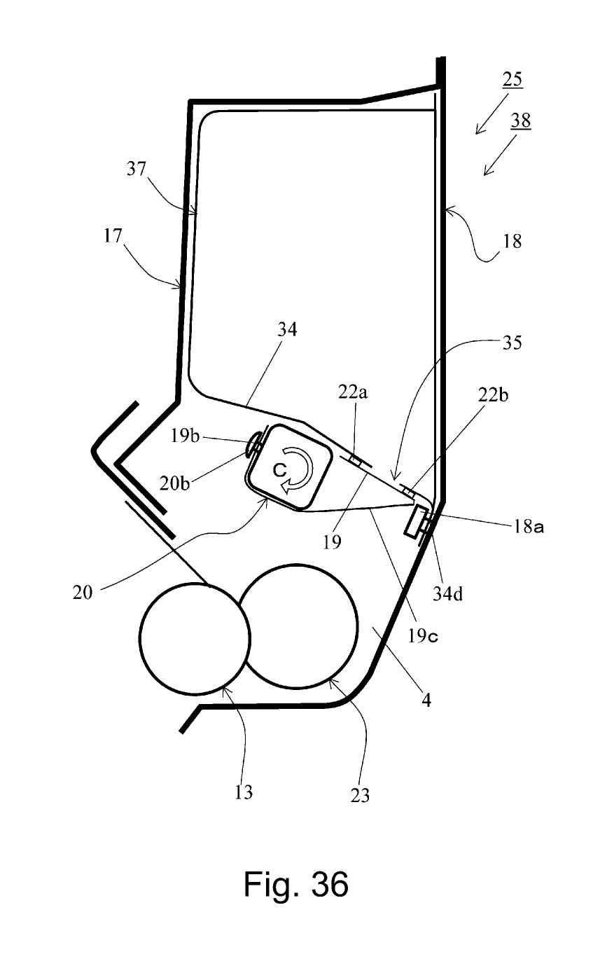

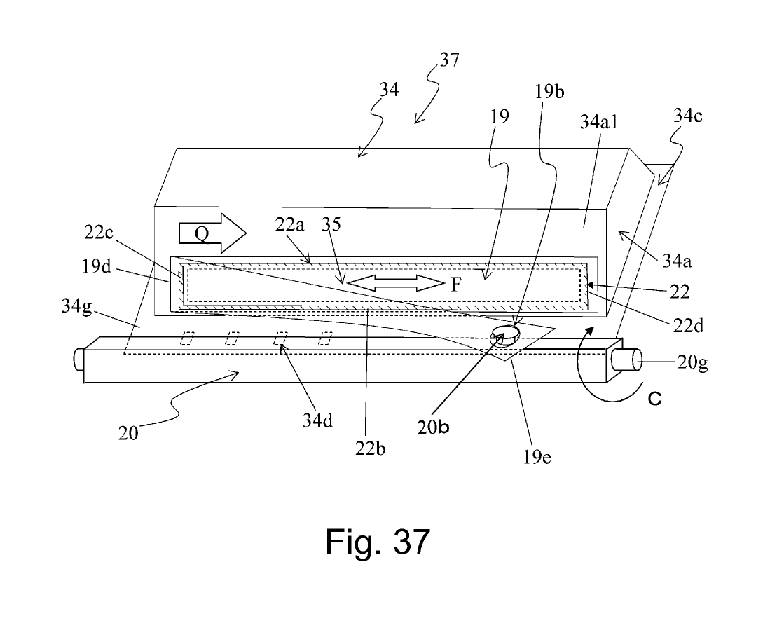

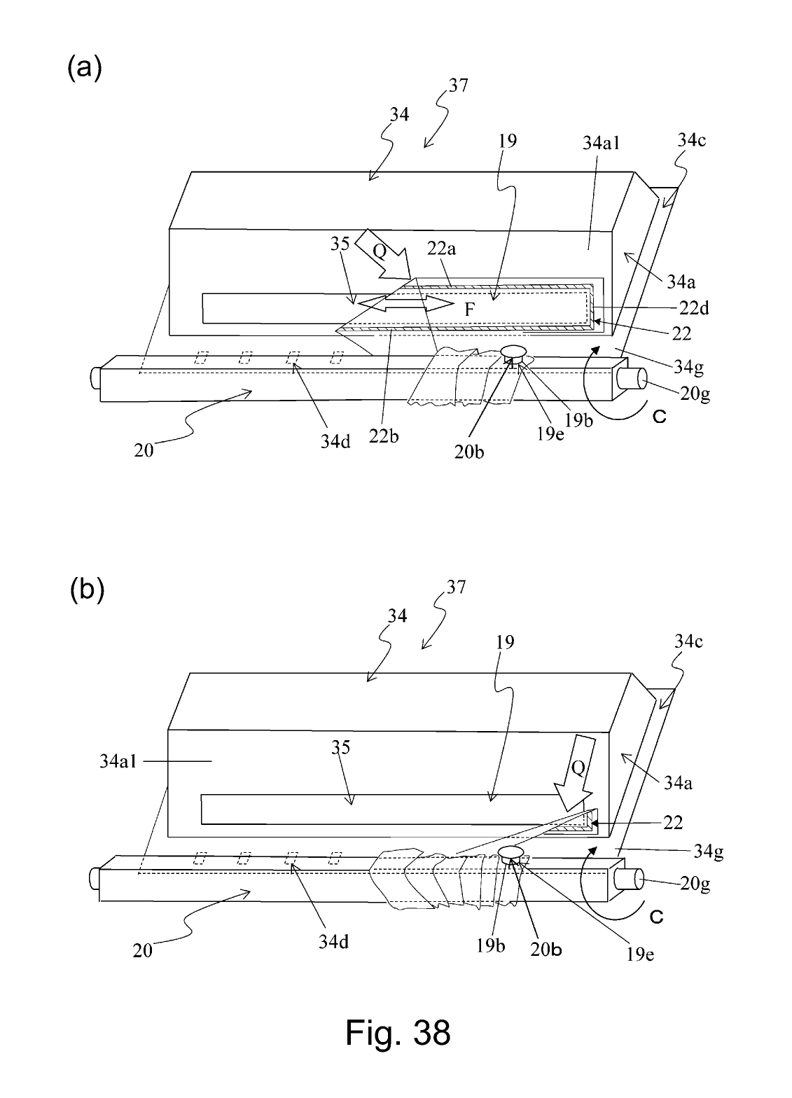

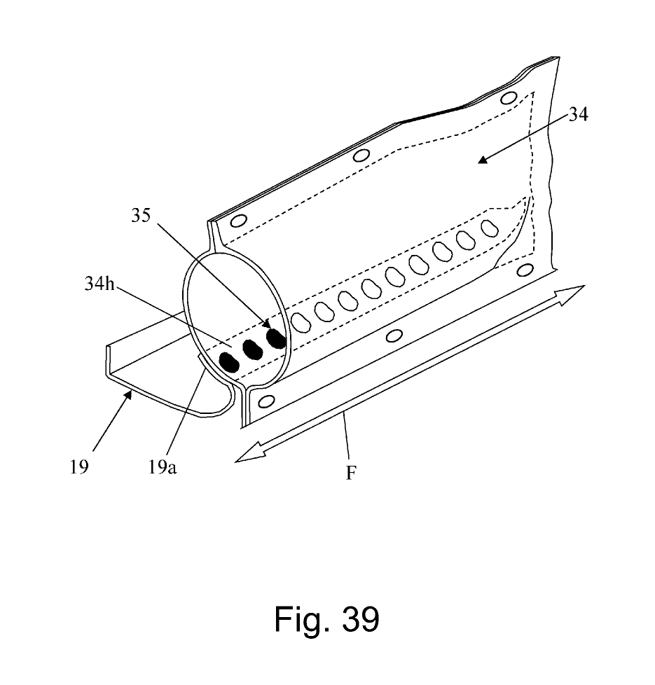

As shown in FIGS. 4, 5 and 8, the developer accommodating member 37 is constituted by the developer, the flexible developer accommodating container 34 accommodating the developer, and a sealing member 19 for unsealably sealing the opening 35 provided in the developer accommodating container 34. The opening 35 in this embodiment is formed long in the same direction as a longitudinal direction (left-right direction of FIG. 5) of the developer accommodating container 34. The sealing member 19 is peelably bonded to a bonding portion 34 provided at a periphery of the opening 35. The bonding portion 22 peelably bonds the periphery of the opening 35 and the sealing member 19. The developer accommodated in the developer accommodating container 34 is powder.

### <Developer Accommodating Container>

As shown in FIG. 8, the flexible developer accommodating container 34 is provided with a single opening 35 for permitting discharge of the developer. At an outer peripheral portion of an edge of the opening 35, the bonding portion 22 is provided. The sealing member 19 is peelably bonded to the bonding portion 22, and the opening 35 is unsealably sealed with the sealing member 19.

The developer accommodating container 34 is provided with a filling port 39, including the opening 35, for permitting filling of the developer inside the developer accommodating container 34, and as shown in part (b) of FIG. 8, after the developer is filled in the developer accommodating container 34 through the filling part 39, the filling part 39 is sealed by a bonding portion 39a. As shown in part (c) of FIG. 8, the opening 35 and the filling port 39 of the developer accommodating container 34 accommodating the developer therein are sealed with the bonding portion 22 and the bonding portion 39a, respectively. As a result, the developer accommodated in the developer accommodating container 34 is prevented from leaking out, so that the developer accommodating member 37 comprising the developer accommodating container 34 and the sealing member 19 can be treated as a single unit.

### <Molded Portion>

A structure of the molded portion 34a of the developer accommodating container 34 will be described. The molded portion 34 is prepared by subjecting a sheet-like material to vacuum molding, air-pressure molding, press molding, or the like. As a material for the molded portion 34a, it is possible to use an acrylonitrile butadiene styrene copolymer (ABS) and polymethylmethacrylate (PMMA). Further, it is also possible to use polycarbonate (PC), polypropylene (PP), polyethylene (PE), high-impact polystyrene (HIPS), polyethylene terephthalate (PET), polyvinyl chloride (PVC), and composite multi-layer materials of these polymers.

As the material of the molded portion 34a, a flexible material may preferably be used for improving discharging efficiency when the developer is discharged through the opening 35 provided in the developer accommodating container 34. Further, also the molded portion 34a may also be formed of an air-permeable material having flexible similarly as an air-permeable portion 34b.

Further, a thickness of the molded portion 34a may preferably be about 0.1 mm to 1 mm as a thickness of the sheet-like member before the molding since the resultant portion is excellent in flexibility. The material and the thickness of the molded portion 34a can be appropriately be set depending on cost, product specifications, manufacturing condition, and the like.

As shown in FIG. 4, the molded portion 34a is bonded to the air-permeable portion 34b at a collar portion 34c provided at a periphery of the molded portion 34a. The developer accommodating member 37 accommodates the developer therein. Further, at a part of a bonding portion 34b where the collar portion 34c and the air-permeable portion 34b are bonded to each other, a fixed portion 34d comprising an edge of a through hole. As shown in FIG. 3, the frame 18 is provided with a fixing portion 18a including a shaft portion 18a1 and a head portion 18a2.

As shown in FIG. 3, the developer accommodating member 37 in which the developer is filled is fixed by being inserted between the frames 17 and 18 and by engaging the fixed portion 34d of the developer accommodating member 37 with the fixing portion 18a of the frame 18. In that state, a shape of the molded portion 34a having flexible follows an inner wall surface of the frames 17 and 18.

### <Air-Permeable Portion>

Air permeability of the air-permeable portion 34b may appropriately be selected so as to be a value to the extent that the developer is not leaked to an outside of the developer accommodating container 34 in view of a balance thereof with a size (particle size of powder) of the developer accommodated in the developer accommodating member 37. As a material of the air-permeable portion 34b, it is possible to use polyester, PET (polyethylene terephthalate), PE (polyethylene), PP (polypropylene) and the like.

A material of the air-permeable portion 34b may preferably be nonwoven fabric having a thickness of 0.03 mm-0.15 mm. The material of the air-permeable portion 34b is not limited to the nonwoven fabric but may also be a material provided with minute holes smaller than a particle size of powder such as the developer accommodated in the developer accommodating container 34. Further, as shown in FIG. 4, the air-permeable portion 34b in this embodiment is disposed over an entire longitudinal region of the developer accommodating container 34 shown by an arrow F direction of FIG. 4.

### <Material and Air Permeability of Developer Accommodating Member>

A filling step of the developer into the developer accommodating member 37 will be described using parts (a) to (c) of FIG. 8. Part (a) of FIG. 8 shows a state in which the developer has not yet been filled in the developer accommodating member 37. At one end portion of the developer accommodating container 34 with respect to the longitudinal direction, the filling port 39 including the opening 35 is provided.

<Filling Operation of Developer into Developer Accommodating Member>

Next, as shown in part (b) of FIG. 8, the developer is filled through the filling part 39 of the developer accommodating container 34. The filling port 39 is deformable in conformity to a nozzle of an unshown filling device since the developer accommodating container 34 has flexibility. For this reason, the developer can be filled in the developer accommodating container 34 through the filling port 39 without being scattered to an outside. When the developer is filled, filling can be carried out using a known auger filling device. Another method having a similar function may also be employed.

Next, as shown in part (c) of FIG. 8, the filling port 39 of the developer accommodating container 34 in which the developer is filled is bonded and sealed by the bonding portion 39a. In this embodiment, the bonding portion 39a is bonded by ultrasonic bonding. As another means, heat, a laser or the like may also be used for the bonding of the bonding portion 39a. As shown in part (c) of FIG. 8, when the filling port 39 of the developer accommodating container 34 filled with the developer by the bonding portion 39a, the developer in the developer accommodating container 34 is sealed up, so that the developer accommodating container 34 can be treated as the developer accommodating member 37 in which the developer is accommodated. Incidentally, a position and a size of the filling port 39 for permitting the filling of the developer therethrough can be appropriately be set in conformity to shapes and the like of the developer filling device and the process cartridge A.

### <Effect of Inclusion of Developer Accommodating Member in Developing Device>

The flexible developer accommodating member 37 in which the developer is accommodated is constituted in a bag shape. As a result, the developer accommodating member 37 in which the developer is accommodated can be treated as a single unit. As a result, the filling step of the developer into the developer accommodating member 37 can be separated from an assembling step (manufacturing line) of the process cartridge A. As a result, in the assembling step (manufacturing line) of the process cartridge A, the developer is prevented from scattering, so that maintenance such as cleaning or the like of the manufacturing line can be reduced. Further, the scattering of the developer is prevented in the assembling step of the process cartridge A, so that a cleaning step of the process cartridge A after the developer is filled can be omitted.

Further, also in the filling step in which the developer is filled in the developer accommodating member 37, the developer accommodating container 34 has flexibility and the filling port 39 through which the developer is filled is also soft, so that the filling port 39 is deformable in conformity to the filling device nozzle or the like. As a result, a degree of the scattering of the developer is small, so that the bonding portion 39a can be easily sealed.

Further, the developer accommodating member 38 in which the developer is accommodated has flexibility, and therefore, when the developer accommodating member 37 is accommodated inside the frames 17 and 18, the developer accommodating member 37 can be incorporated in the frames 17 and 18 so as to follow an inner wall shape of the frames 17 and 18. Further, in the developer filling step, the developer accommodating member 37 has flexibility, and therefore, a cross-sectional portion of the developer accommodating member 37 is deformed and thus a volume is increased, so that a filling amount can be increased.

Further, the developer accommodating member 37 before the developer is filled therein has flexibility, and therefore, can be made small (thin in thickness). For this reason, compared with the case where a frame comprising a resin-made structure is used as a developer container, a storage space during storage of the developer accommodating member 37 before the developer is filled can be decreased.

### <Effect of Air Permeability of Developer Accommodating Member>

The reason why the air permeability is imparted to the developer accommodating member 37 is that the developer accommodating member 37 is capable of meeting during manufacturing of the process cartridge A, during storage, during transportation until a user uses the process cartridge A, and the like.

### <During Manufacturing of Process Cartridge>

The reason during manufacturing of the process cartridge A is that the developer accommodating member 37 is made deformable and contractable. In the case where the developer accommodating member 37 is not provided with the air-permeable portion 34b, the size of the developer accommodating member 37 cannot be changed from a state in which the developer is filled in the developer accommodating member 37, and therefore, the developer accommodating member 37 is not readily deformed. For that reason, an operation in which the developer accommodating member 37 is inserted and assembled into a unit in the frames 17 and 18 requires much time, so that an assembling step becomes complicated.

In this embodiment, the air permeability is imparted to at least a part of the developer accommodating member 37. As shown in part (b) of FIG. 8, the developer is filled in the developer accommodating member 37 through the filling port 39. Thereafter, as shown in part (c) of FIG. 8, from a size of the developer accommodating member 37 in a state in which the bonding portion 39a is sealed up and closed, only the air in the developer accommodating member 39 is discharged to the outside. As a result, the size of the developer accommodating member 37 can be changed, so that the operation in which the developer accommodating member 37 is inserted and assembled into a unit in the frames 17 and 18 is easily performed.

### <During Transportation and During Storage Process Cartridge>

Next, the reason during transportation and during storage of the process cartridge A is that the developer accommodating member 37 meets a change in atmospheric pressure during transportation and during storage of the process cartridge A. In the case where the developer accommodating member 37 is in an environment lower in atmospheric pressure during manufacturing of the process cartridge A than during transportation of the process cartridge A or in the case where the developer accommodating member 37 is stored in an environment in which a temperature is higher than that during manufacturing of the process cartridge A, a difference in atmospheric pressure generates between the inside and the outside of the developer accommodating member 37. For that reason, the air in the developer accommodating member 37 expands, so that there is a liability that respective component parts contacting the developer accommodating member 37 are deformed or broken.

As a result, there is a need to control the atmospheric pressure and the temperature during transportation and during storage of the process cartridge A, so that an equipment cost increases. In this embodiment, a problem due to the difference in atmospheric pressure between the inside and the outside of the developer accommodating member 37 can be solved by imparting a part of the developer accommodating member 37. Further, in the case where an air-permeable nonwoven fabric is provided with the opening 35 or the bonding portion 22 is provided in the neighborhood of an edge of the opening 35, there is a liability that with peeling of the sealing member 19 during unsealing the sealing member 19, fibers of the nonwoven fabric fall off and enter the developer and thus has an adverse influence on the image.

For that reason, the opening 35 is provided in the molded portion 34a different from the sheet-shaped air-permeable portion 34b, whereby the fibers of the nonwoven fabric are prevented from falling off. Further, the developer is filled in the developer accommodating member 37 while discharging the air in the developer accommodating member 37 through the sheet-shaped air-permeable portion 34b, whereby a filling density of the developer filled in the developer accommodating member 37 can be increased.

<Developer Accommodating Member with No Air Permeability>

On the other hand, in the case where an effect of imparting the air to permeability to the developer accommodating member 37 is not needed, the developer accommodating member 37 may only be required to be constituted by a non-air-permeable material.

### <Operating of Developer Accommodating Container>

As shown in FIGS. 4 and 6, the developer accommodating container 34 is provided with the opening 35 which is a discharging portion for permitting discharge of the developer accommodated therein. In the neighborhood of a peripheral edge of the opening 35, the bonding portion 22 continuously enclosing an entire periphery of the opening 35 is provided. To the bonding portion 22, the sealing member 19 is peelably bonded. As a result, the developer accommodated in the developer accommodating container 34 is unsealably sealed with the sealing member 19.

### <Arrangement of Opening of Developer Accommodating Container>

Next, arrangement of the opening 35 of the developer accommodating container 34 will be described using FIG. 6. The sealing member 19 not only seals the opening 35 peelably welded to the bonding portion 22 and provided in the developer accommodating container 34 but also is moved by being pulled in an arrow D direction of parts (a) and (b) of FIG. 6, so that the bonding portion 22 is peeled and thus the opening 35 is exposed. By movement of the sealing member 19, exposure of the opening 35 along an unsealing direction shown by an arrow E direction of parts (a) and (b) of FIG. 6 progresses. An elongated opening 35 is disposed along an arrow F direction of parts (a) and (b) of FIG. 6 perpendicular to the unsealing direction shown by the arrow E direction of parts (a) and (b) of FIG. 6.

The sealing member 19 in this embodiment has a constitution in which the sealing member 19 is wound up about an outer periphery of the unsealing member 20 by rotating the unsealing member 20 is employed. The arrow F direction of parts (a) and (b) of FIG. 6 is the same direction as an axial direction of a rotation shaft 20g of the unsealing member 20. Further, the arrow F direction of parts (a) and (b) of FIG. 6 is also the same direction as a rotational axis direction of the developing roller 13.

The rotational axis direction of the developing roller 13 and the longitudinal direction of the opening 35 shown by the arrow F direction of parts (a) and (b) of FIG. 6 are made parallel to each other. As a result, when the developer in the developer accommodating container 34 is discharged through the opening 35 by unsealing the opening 35, the developer is easily supplied over an entirety of the developing roller 13 with no bias. Further, the unsealing direction of the opening 35 is a widthwise direction of the opening 35 shown by the arrow E direction of parts (a) and (b) of FIG. 6, and therefore, a distance required to unseal the opening 35 is shorter than a distance required to unseal the opening 35 in the arrow F direction of parts (a) and (b) of FIG. 6, and therefore, a time required for unsealing the opening 35 can be shortened.

Further, a constitution in which the sealing member 19 sealing the opening 35 is wound up by the unsealing member 20 is employed. The direction of the rotation shaft 20g of the unsealing member 20 and the longitudinal direction of the opening 35 shown by parts (a) and (b) of FIG. 6 perpendicular to the unsealing direction of the opening 35 shown by the arrow E direction of parts (a) and (b) of FIG. 6 are the same (parallel) direction. As a result, a winding distance of the sealing member 19 can be shortened, so that a winding time can be shortened.

### <Shape and Direction of Opening of Developer Accommodating Container>

The opening 35 in this embodiment has a rectangular shape. When a discharging property when the developer accommodated in the developer accommodating container 34 in discharged through the opening 35 is taken into consideration, an area of the opening 35 may preferably be large. The size and shape of the opening 35 are required to achieve a balance based on a material and thickness of the reinforcing member 41 provided close to the edge of the opening 35 and further based on a force relationship with a peeling strength of the sealing member 19 when the opening 35 is unsealed, and the like. Incidentally, the shape of the opening 35 may also be various shapes such as polygonal shapes, elongated hole shapes and the like, other than the rectangular shape.

A direction of a plane including the opening 35 may preferably be such that as shown in FIG. 1, the developer accommodated in the developer accommodating member 37 is easily discharged through the opening 35 in an attitude during image formation in which the process cartridge A is mounted in the main assembly of the image forming apparatus B. For that reason, as shown in FIG. 1, in the attitude of the process cartridge A during image formation, the opening 35 is disposed so as to open with respect to a direction of gravitation (downward direction of FIG. 1). Here, opening of the opening 35 with respect to the direction of gravitation refers to that a direction perpendicular to the plane including the opening 35 has a component of the direction of gravitation.

### <Bonding Portion of Developer Accommodating Member>

The bonding portion 22 provided in the neighborhood of the peripheral edge of the opening 35 of the developer accommodating container 34 includes first and second bonding portions 22a and 22b provided along the longitudinal direction of the opening 35 shown by the arrow F direction of FIGS. 5 and 6. Further, the bonding portion 22 includes third and fourth bonding portions 22c and 22d provided along the widthwise direction of the opening 35 shown by the arrow E direction of FIGS. 5 and 6. These bonding portions 22 (22a to 22d) are continuous in a rectangular shape enclosing the peripheral edge of the opening 35.

As a result, the sealing member 19 is peelably bonded to the bonding portion 22, so that the opening 35 is sealable by the sealing member 19. The first bonding portion 22a of the first and second bonding portions 22a and 22b peelably welded along the longitudinal direction of the opening 35 shown by the arrow F direction of FIGS. 5 and 6 is unsealed early. After the first bonding portion 27a is unsealed, the third and fourth bonding portions 22c and 22d are unsealed, and thereafter, the second bonding portion 22b is unsealed.

The developer accommodating container 34 includes a fixed portion which is a fixing portion fixable in the neighborhood of the opening 35. In this embodiment, in the case where the developer accommodating container 34 is seen along a surface of the sealing member 19 of part (a) of FIG. 5, the first bonding portion 22a is provided on a side close to the fixed portion 34d comprising edges of through holes engaged with and fixed to the fixing portion 18a of the frame 18. Further, the second bonding portion 22b opposing the first bonding portion 22a while sandwiching the opening 35 therebetween is provided. The associated end portions of the first and second bonding portions 22a and 22b with respect to the longitudinal direction on each of one side and the other side are continuously connected by the third and fourth bonding portions 22c and 22d.

An arrow T direction of part (b) of FIG. 7 is a thickness direction of a bottom 34a1 (in the plane including the opening 35) of the molded portion 34a of the developer accommodating container 34. In other words, this thickness direction can also be said as a direction perpendicular to the plane including the opening 35. As seen in the thickness direction, the second bonding portion 22b and the reinforcing member 41 are disposed in an overlapping manner. Incidentally, as shown in part (c) of FIG. 7, as seen in the thickness direction, a part of the second bonding portion 22b and a part of the reinforcing member 41 may also be disposed in the overlapping manner. The sealing member 19 in this embodiment is pulled in the arrow D direction of parts (a) and (b) of FIG. 6, so that the bonding portion 22 is unsealed in the unsealing direction shown by the arrow E direction of parts (a) and (b) of FIG. 6. Incidentally, the overlapping between the part of the second bonding portion 22b and the part of the reinforcing member 41 as seen in the thickness direction or in the arrow T direction means the following phenomenon. That is, the overlapping refers to that when each of the second bonding portion 22b and the reinforcing member 41 is projected on a phantom plane perpendicular to the arrow T direction, at least a part of ordinate or position on the phantom plane is common to the second bonding portion 22b and the reinforcing member 41.

Here, the unsealing direction of the bonding portion 22 is defined in the following manner. In the case where the bonding portion 22 is unsealed by movement of the sealing member 19 by pulling the sealing member 19 in the arrow D direction of parts (a) and (b) of FIG. 6, the first bonding portion 22a of the first and second bonding portions 22a and 22b sandwiching the opening 35 therebetween is peeled and unsealed early. Thus, the arrow E direction of parts (a) and (b) of FIG. 6 from the first bonding portion 22a unsealed early toward the second bonding portion 22b unsealed later is defined as the unsealing direction.

### <Fixing of Developer Accommodating Member>

The developer accommodating member 37 shown in FIG. 4 is accommodated inside the frames 17 and 18 as shown in FIG. 3. The fixed portion 34d comprising the edges of the through holes provided in the bonding portion 34g of the developer accommodating member 37 shown in FIG. 4 is fitted and locked to the shaft portion 18a1 of the fixing portion 18a provided on the frame 18 and thus is fixed to the fixing portion 18.

### <Fixed Portion>

As shown in parts (a) and (b) of FIG. 6, the opening 35 is unsealed by peeling off the sealing member 19 from the bonding portion 22 provided in the neighborhood of the peripheral edge of the opening 35 of the developer accommodating container 34. At that time, the fixed portion 34d comprising the edges of the through holes provided in the bonding portion 34g of the developer accommodating member 37 fitted and locked to the shaft portion 18a1 of the fixing portion 18 provided on the frame 18 receives a force.

The fixed portion 34d is provided at a plurality of positions along the longitudinal direction of the opening 35 shown by the arrow F direction of parts (a) and (b) of FIG. 6. The fixed portion 34d comprises rectangular through holes. Further, the shape of the fixed portion 34d can be appropriately selected from a circular shape and various polygonal shapes and the like in view of the force exerted on the fixed portion 34d and manufacturing convenience.

As shown in FIG. 3, the fixed portion 34d is provided in the neighborhood of the opening 35 of the developer accommodating container 34. The fixed portion 34d is a fixing portion necessary to support the developer accommodating member 37 against a tensile force of the sealing member 19 when the opening 35 of the developer accommodating container 34 is unsealed by winding up the sealing member 19 by the unsealing member 20.

### <Fixing Method of Developer Accommodating Member and Frame>

A fixing method of the fixed portion 34d of the developer accommodating member 37 will be described. A base provided so as to stand on an inner wall surface of the frame 18 shown in FIG. 3 is caused to pass through an associated one of the fixed portions 34d provided in the bonding portion 34g of the developer accommodating member 37 shown in FIG. 4 and comprising the edges of the through holes. Then, a free end portion (head portion) of the boss is flattened by thermal caulking or ultrasonic caulking, so that a head portion 18a2 larger in outer diameter than the shaft portion 18a1 is formed and thus the fixing portion 18a is provided as shown in an enlarged portion of FIG. 3.

As another method, the developer accommodating member 37 may also be fixed to the frame 17 and/or 18 by being directly subjected to thermal welding or ultrasonic welding. Further, the developer accommodating member 37 may also be fixed to the frame 17 and/or 18 being bonded with a solvent or an adhesive. Further, the developer accommodating member 37 may also be fixed by being nipped between the frames 17 and 18 or may also be fixed to the frame 17 and/or 18 with screw(s). Further, holes provided in the developer accommodating member 37 may also be locked by being hooked on projections such as basses or the like provided on the frame 18 and/or 18.

### <Sealing Member>

Next, a structure of the sealing member 19 will be described using FIGS. 3, 4, 9 and 14. Parts (a) to (c) of FIG. 9 are partially sectional views showing a process of unsealing the opening 35 provided in the developer accommodating container 34 in this embodiment. FIG. 14 is a sectional view showing a structure of the developer accommodating container 34 in this embodiment in the neighborhood of the opening 35.

As shown in FIGS. 3 and 4, the sealing member 19 seals up the developer accommodated in the developer accommodating member 37 by covering the opening 35 of the developer accommodating container 34 before use of the process cartridge 4. The sealing member 19 is wound up by the unsealing member 20 rotating in the arrow C direction of FIGS. 3 and 4 and is moved in the arrow D direction. As a result, the bonding portion 22 is peeled off, so that the opening 35 is exposed.

The sealing member 19 is constituted by including a sealing portion 19a covering the opening 35 of the developer accommodating container 34, a portion-to-be-engaged 19b fixed to the unsealing member 20, and a connecting portion 19c connecting the sealing portion 19a and the portion-to-be-engaged 19b. The sealing member 19 is formed of a laminate material having a sealant layer easily peelable from the bonding portion 22, and as a base material, polyethylene terephthalate (PET) is applicable. Further, polyethylene (PE), polypropylene (PP) or the like is applicable to the base material. A thickness of the sealing member 19 may appropriately selected from a range of 0.03 mm to 0.15 mm.

### <Sealing Portion of Sealing Member>

The sealing portion 19a of the sealing member 19 is a region where the opening 35 of the developer accommodating container 34 is sealed. By sealing the opening 35 with the sealing portion 19a, until before the process cartridge A is used, the developer accommodated in the developer accommodating member 37 is prevented from leaking out of the developer accommodating member 37.

### <Portion-to-be-Engaged of Sealing Member>

The sealing member 19 has a sheet shape and is provided with a free end portion 19e on one end side with respect to the unsealing direction shown by the arrow D direction of parts (a) to (c) of FIG. 9, and the free end portion 19e is provided with the portion-to-be-engaged 19b comprising a through hole. The portion-to-be-engaged 19b is locked by being engaged with a shaft portion 20b1 of an engaging portion 20b fixed to an outer peripheral surface of the unsealing member 20.

The flexible sealing member 19 is wound up about an outer periphery of the unsealing member 20 by rotation of the unsealing member 20 about a rotation axis 20g as a rotation center in the arrow C direction, and is moved in the arrow D direction of part (b) of FIG. 9. On the other hand, the fixed portion 34d of the bonding portion 34g of the developer accommodating member 37 provided in the neighborhood of the first bonding portion 22a is fixed to the fixing portion 18a of the frame 18.

As a result, the first bonding portion 22a is peeled early, and then the third and fourth bonding portions 22c and 22d are continuously peeled, and finally, the second bonding portion 22b is peeled. As a result, the opening 35 of the developer accommodating container 34 is exposed. As shown in FIGS. 9 and 10, the developer accommodating container 34 has flexibility, and therefore, by the rotation of the unsealing member 20, at least a part of the developer accommodating container 34 is deformed during peeling of the sealing member 19 from the developer accommodating container 34 and when the sealing member 19 is peeled from the developer accommodating container 34.

Rotational drive of the unsealing member 20 may also be carried out by transmitting a rotational driving force thereto from a motor which is a driving source provided in the main assembly of the image forming apparatus B, so that the unsealing of the sealing member 19 may be automatically carried out. As another method, the unsealing of the sealing member 19 may also be carried out by movement of the unsealing member 20 by gripping the unsealing member 20 by a user. The unsealing member 20 in this embodiment comprises a rotation shaft rotatably supported by the frames 17 and 18. The sealing member 19 locked at the free end portion 19e thereof by the unsealing member 20 is wound about the outer periphery of the unsealing member 20 rotating in the arrow C direction of part (b) of FIG. 9, and thus is pulled in the arrow D direction of part (b) of FIG. 9. As a result, the opening 35 of the developer accommodating container 34 is unsealed.

### <Connecting Portion of Sealing Member>

A portion connecting the sealing portion 19a, peelably bonded to the bonding portion 22 provided in the neighborhood of the peripheral edge of the opening 35 of the developer accommodating container 34, and the free end portion 19e provided with the portion-to-be-engaged 19b is the connecting portion 19c. The connecting portion 19c is a portion wound about the outer periphery of the unsealing member 20 and receiving a tensile force in the arrow D direction of part (b) of FIG. 9 and transmitting the force so as to peel off the bonding portion 22.

### <Fold-Back Portion of Connecting Portion of Sealing Member>

As shown in FIG. 14, at the instant when the first bonding portion 22a is peeled by pulling the sealing member 19 by the unsealing member 20, a plane including the bonding portion 22 and parallel to the plane including the opening 35 is N1. A plane perpendicular to the plane N1 and passing through the first bonding portion 22a is N2.

The unsealing member 20 is disposed on a side closer to the second bonding portion 22b than the plane N2 passing through the first bonding portion 22a is. In other words, when the sealing member 19 is seen along a surface thereof, at the connecting portion 19c between the first bonding portion 22a and the portion-to-be-engaged 19b engaged with the engaging portion 20b of the unsealing member 20, a fold-back portion 19d is provided. The fold-back portion 19d may be provided with a fold (crease) or with no fold in advance.

A folding angle θ1 of the fold-back portion 19d may preferably be 90 degrees or less. Here, the plane N1 including the bonding portion 22 of the developer accommodating container 34 and parallel to the plane including the opening 35 will be considered. Further, a plane N3 on which a corner 20f of a square-shaped unsealing member 20 contacts the sealing member 19 and the sealing member 19 is pulled and which extends along the arrow D direction of FIG. 14 will be considered. The folding angle θ1 is an angle of an intersection of the planes N1 and N3 and is an angle which is not an obtuse angle.

### <Fixing of Sealing Member>

Fixing of the sealing member 19 and the unsealing member 20 is carried out by the ultrasonic caulking similarly as in the fixing of the fixed portion 34d described above. The fixing of the sealing member 19 and the unsealing member 20 may also be carried out by thermal welding, ultrasonic welding or (adhesive) bonding, other than the ultrasonic caulking. As another method, a hooking in which the portion-to-be-engaged 19b comprising the through hole is locked by a projection which stands on an outer peripheral surface of the unsealing member 20, or the like method may also be used.

### <Peeling of Sealing Member>

Next, a method in which a peeling force of the sealing member 19 bonded to the bonding portion 22 is set at a desired value will be described. In this embodiment, in order to set the peeling force of the sealing member 19 bonded to the bonding portion 22 at the desired value (in this embodiment, a force which is an small as possible within a range in which a developer sealing property can be maintained), two methods are principally employed.

### <First Method>

A first method is such that a laminate material having a sealant layer is used as the material of the sealing member 19 and thus peeling of the sealing member 19 bonded to the bonding portion 22 is made easy. Further, as the material of the developer accommodating container 34, a sheet material of polyethylene, polypropylene or the like, capable of being welded to the sealant layer of the sealing member 19 and having flexibility is used. As a result, the sealing member 19 bonded to the bonding portion 22 can be easily peeled. By changing formulation of the sealant layer of the sealing member 19 or a combination of materials to be bonded to each other, the peeling force of the sealing member 19 bonded to the bonding portion 22 can be adjusted in conformity to a desired condition. In this embodiment, the sealing member 19 having a peeling strength of about 3 N/15 mm as measured in “Testing methods for sealed flexible packages” according to JIS Z 0238 is used.

### <Second Method>

A second method is such that as shown in FIG. 9, the sealing member 19 is placed in a state in which the sealing member 19 is folded back at the fold-back portion 19d with respect to a direction (arrow E direction of part (b) of FIG. 9) in which unsealing of the opening 35 of the developer accommodating container 34 progresses. In a state shown in FIG. 3, the sealing member 19 is wound up about the outer periphery of the unsealing member 20 by rotating the unsealing member 20 in the arrow D direction of FIG. 3, so that the sealing member 19 is pulled in the arrow D direction.

At this time, as shown in FIG. 14, the plane N1 including the bonding portion 22 of the developer accommodating member 37 and parallel to the plane including the opening 35 will be considered. Further, the plane N3 extending along the arrow D direction of FIG. 14 in which the sealing member 19 is pulled will be considered. The planes N1 and N3 are in a positional relationship such that the angle θ1 (folding angle θ1 of the fold-back portion 19d) which is the angle of intersection between the planes N1 and N3 and which is not an obtuse angle is 90 degrees or less and thus inclination peeling is carried out.

In this way, by performing the inclination peeling, a peeling force required when the sealing member 19 is peeled off of the bonding portion 22 can be reduced. The sealing member 19 is placed in a state in which the sealing member 19 is folded back at the fold-back portion 19d with respect to the direction (arrow E direction of FIG. 14) in which the unsealing the opening 35 of the developer accommodating container 34 progresses. As a result, the bonding portion 22 of the developer accommodating member 37 and the sealing member 19 are in the positional relationship of the inclination peeling, so that the peeling force of the sealing member 19 bonded to the bonding portion 22.

### <Unsealing Member>

A structure of the unsealing member 20 will be described using FIGS. 3 and 9. As shown in FIG. 9, the unsealing member 20 is used for peeling off the sealing member 19 from the developer accommodating container 34 by moving the sealing member 19 while imparting a force to the sealing member 19. The unsealing member 20 in this embodiment has a shaft shape and is rotatably supported by the frame 18 at longitudinal end portions.

### <Combined Use as Unsealing Member, Urging Member and Stirring Member>

In a state in which the developer accommodating member 37 is mounted in the image forming apparatus B, the bottom 34a1 of the molded portion 34a of the developer accommodating container 34 is disposed in an inclined state. The unsealing member 20 in this embodiment functions as an urging member for urging discharge of the developer, accommodated in the developer accommodating container 34, through the opening 35 by striking the bottom 34a1 with an urging sheet 21b at a predetermined interval. Further, the unsealing member 20 also functions as a stirring member for feeding the developer toward the developing roller 13 while stirring the developer discharged from the developer accommodating container 34 into a developing chamber 4 through the opening 35.

The unsealing member 20 and the urging member for discharging the developer from an inside of the developer accommodating member 37 by externally acting on the developer accommodating member 37 may also be constituted as separate members. In this embodiment, the unsealing member 20 and the urging member are constituted by the same component part, so that the number of component parts can be reduced.

### <Effect of Combined Use as Unsealing Member, Urging Member and Stirring Member>

Thus, the unsealing member 20 also functions as the urging member and the stirring member, whereby it becomes possible to realize a cost reduction by reducing the number of component parts and to realize space saving of the apparatus.

### <Unsealing Operation>

An unsealing operation of the opening 35 of the developer accommodating container 34 will be described using FIGS. 6, 9-11, 15 and 16. Parts (a) and (b) of FIG. 10 are partially sectional views showing a process of unsealing the opening 35 in the case where the reinforcing member 41 is provided on the inner surface side of the developer accommodating container 34 in this embodiment. FIG. 11 is a sectional view showing a structure of the developing device 38 after the opening 35 provided in the developer accommodating container 34 in this embodiment is unsealed (opened). FIG. 15 is a sectional view showing a structure of the developing device 37 immediately before the opening provided in the developer accommodating container 34 in this embodiment is unsealed. FIG. 16 is a sectional view showing a structure of the developing device 38 during unsealing of the opening 35 provided in the developer accommodating container 34 in this embodiment.

As shown in part (b) of FIG. 9, in order to unseal the opening 35 provided in the developer accommodating container 34, the unsealing member 20 having a square shape in cross-section includes a force application portion 20a comprising the corner (portion) 20c and providing a force for pulling the sealing member 19. The fixing portion 18a provided on the frame 18 fixes and supports the developer accommodating container 34 pulled in the arrow D direction of part (b) of FIG. 9 through the bonding portion 22 by the sealing member 19 moving in the arrow D direction of part (b) of FIG. 9.

As shown in part (b) of FIG. 9 and part (a) of FIG. 10, the force application portion 20a comprising the corner 20c of the unsealing member 20 having the square shape in cross-section refers to a portion, closest to the bonding portion 22, of a portion where the sealing member 19 and the unsealing member 20 contact each other at the instance when the sealing member 19 is peeled off from the bonding portion 22. In part (b) of FIG. 9, the corner 20c of the unsealing member 20 is the force application portion 20a. Further, the fixing portion 18a of frame 18 suppresses movement of the developer accommodating container 34 against the force for pulling the sealing member in the arrow D direction of part (b) of FIG. 9 when the sealing member 19 is peeled from the bonding portion 22.

In this embodiment, the fixing portion 18a of the frame 18 and the fixed portion 34d comprising the through hole edge portion of the developer accommodating member 37 are bonded to each other by the ultrasonic caulking. As shown in parts (b) and (c) of FIG. 9 and part (a) of FIG. 10, a corner (portion) 18a3, close to the bonding portion 22, of a wide head portion 18a2 formed at a free end portion of the fixing portion 18a by the ultrasonic caulking is a fixed point 18c.

### <Drive Transmitting Mechanism>

A structure of a drive transmitting mechanism for rotationally driving the unsealing member 20 will be described using FIG. 3. As shown in FIG. 3, the unsealing member 20 is rotated in the arrow C direction by transmitting thereto a rotational driving force from an unshown motor which is a driving source. Rotation of the unsealing member 20 progresses, so that the sealing member 19 is wound up about the outer periphery of the unsealing member 20 and thus is pulled in the arrow D direction of FIG. 3.

Part (a) of FIG. 6, part (b) of FIG. 9 and FIG. 15 show a state immediately before unsealing of the first bonding portion 22a is started by pulling of the sealing member 19 in the arrow D direction by the unsealing member 20. With rotation of the unsealing member 20, the sealing member 19 locked and fixed at the portion-to-be-engaged 19b by the engaging portion 20b of the unsealing member 20 is pulled in the arrow D direction by the force application portion 20a where the sealing member 10 contacts the corner 20c of the unsealing member 20 having the square shape in cross-section.

When the sealing member 19 is pulled in the arrow D direction, the developer accommodating container 34 is pulled through the bonding portion 22. Then, the force is exerted on the fixed portion 34d comprising the through hole edge portion of the developer accommodating container 34, so that the developer accommodating container 34 is pulled in an arrow H direction from the fixed point 18c toward the force application portion 20a by the fixing point 18c comprising the corner 18a3 of the head portion 18a2 of the fixing portion 18a. Then, in a cross-section perpendicular to the rotation axis 20g of the unsealing member 20, the first bonding portion 22a moves so as to approach a rectilinear line (the plane N3 of FIG. 14) connecting the force application portion 20a and the fixing point 18c.

At this time, with respect to the arrow D direction, in an order of being closer to the rotation axis 20g of the unsealing member 20, the opening 35, the first bonding portion 22a, the fold-back portion 19d and the fixing point 18c are disposed. The sealing member 19 is folded back at the fold-back portion 19d between the first bonding portion 22a and the portion-to-be-engaged 19b. For this reason, a force is exerted on the bonding surface of the first bonding portion 22a so as to perform the inclination peeling in the arrow D direction. Then, the peeling of the first bonding portion 22a is performed, and the unsealing of the opening 35 starts. As shown in part (b) of FIG. 9, the developer accommodating container 34 has flexibility, and therefore, when the sealing member 19 is peeled from the developer accommodating container 34 (bonding portion 22a), at least a part of the developer accommodating container 34 is deformed.

As shown in part (b) of FIG. 9, by rotation of the unsealing member 20 in the arrow C direction, together with the corner 20c, also the force application portion 20a is rotationally moved in the arrow C direction. Then, as shown in part (c) of FIG. 9, the force application portion 20a where a corner 20d positioned downstream of the corner 20c with respect to the arrow C direction and the unsealing member 19 are in contact with each other moves from the corner 20c to the corner 20d. Part (b) of FIG. 9 shows a state in which the force application portion 20a is positioned at the corner 20c, and part (c) of FIG. 9 shows a state in which the force application portion 20a is moved to the corner 20d by rotation of the unsealing member 20 in the arrow C direction. As shown in part (c) of FIG. 9 and FIG. 16, with progression of the unsealing of the opening 35 as the rotation of the unsealing member 20 progresses, also the fold-back portion 19d progresses in the arrow E direction. Then, the unsealing further progresses, so that the opening 35 is exposed.

Part (a) of FIG. 10 shows a state in which after the opening 35 is exposed, the sequence goes to peeling of the second bonding portion 22b. Also at this time, similarly as the above-described peeling of the first bonding portion 22a, the sealing member 19 is pulled in the arrow D direction by the force application portion 20a where the sealing member 19 contacts a corner 20e of the unsealing member 20 rotating in the arrow C direction of part (a) of FIG. 10. On the other hand, the developer accommodating container 34 stands firm with respect to the direction of the fixing point 18c shown by the arrow H direction of part (a) of FIG. 10 through the connecting portions on both sides of the opening 35.

Then, in a cross-section perpendicular to the rotation axis 20g of the unsealing member 20, the second bonding portion 22b moves so as to approach a rectilinear line connecting the force application portion 20a and the fixing point 18c. Then, a force in the arrow D direction is exerted on a portion of the second bonding portion 22b of the sealing member 19, so that the second bonding portion 22b is peeled off. Then, as shown in part (b) of FIG. 10 and FIG. 11, the sealing member 19 is peeled off of the second bonding portion 22b, so that an unsealing operation of the opening 35 is completed. Then, the developer in the developer accommodating container 34 is discharged in the arrow I direction through the opening 35.

Thus, the sealing member 19 is wound up by rotation of the unsealing member 20, and the sealing member 19 is peeled off of the unsealing member 20, so that the opening 35 is unsealed. The sealing member 19 is wound up by rotation of the unsealing member 20, and therefore, a space need to move the unsealing member 20 may only be required to be a rotation space of the unsealing member 20, so that space saving of the apparatus can be realized compared with the case where the sealing member 19 is moved by movement thereof in a rectilinear direction or the like other than the rotation thereof.

Further, the opening 35 may also be exposed by manually winding up the sealing member 19 through rotation of the unsealing member 20 by the user. As in this embodiment, the winding-up of the sealing member 19 by rotation of the unsealing member 20 by the rotational driving force from a motor which is a driving source provided in the main assembly of the image forming apparatus B may preferably be employed since it does not cause trouble to the user.

Further, by providing the sealing member 19 with the fold-back portion 19d, when the sealing member 19 is peeled off of the bonding portion 22, inclination peeling can be performed without using shearing peeling, so that the sealing member 19 can be peeled off reliably with a small force. Further, as regards the sealing member 19, at the free end portion 19e provided on one end side of the sealing member 19 along a direction substantially perpendicular to the longitudinal direction of the opening 35 shown by the arrow F direction, the portion-to-be-engaged 19b to be engaged with the engaging portion 20b of the unsealing member 2 is provided. As a result, the sealing member 19 is engaged with the unsealing member 20, so that the opening 35 can be unsealed with reliability.

Further, the fixing point 18c contacting the developer accommodating container 34 is provided at the head portion 18a2 of the fixing portion 18a provided on the frame 18. As a result, the developer accommodating container 34 is supported when the sealing member 19 is peeled off of the bonding portion 22. As a result, even when the soft and deformable developer accommodating container 34 is used, the sealing member 19 can be peeled off of the bonding portion 22 with reliability, so that the opening 35 is unsealable.

Further, as regards the discharge of the developer during the unsealing of the opening 35, as described above, during the unsealing of the opening 35, the bonding portion 22 moves to the rectilinear line (the plane N3 extending along the arrow D direction of FIG. 14 in which the sealing member 19 is pulled) connecting the force application portion 20a and the fixing point 18c which are shown in FIG. 14. This process is shown in part (a) of FIG. 9, part (b) of FIG. 9, part (c) of FIG. 9 and part (a) of FIG. 10 in a named order. Thus, together with the bonding portion 22, the developer accommodating container 34 moves in the arrow D direction of FIG. 14, so that the developer positioned at a periphery of the opening 35 is moved and thus agglomeration of the developer can be collapsed.

### <Positional Relationship Among Fixing Portions Relating to Unsealing>

In order to reliably peel off the sealing member 19 from the second bonding portion 22b, as shown in part (c) of FIG. 9 and parts (a) and (b) of FIG. 10, the following positional relationship is required to be satisfied between the second bonding portion 22b and the fixing point 18c. During the unsealing of the opening 35, the unsealing member 20 pulls the sealing member 19 relative to the fixing point 18c in the arrow D direction of part (a) of FIG. 10. At this time, with respect to the movement direction of the sealing member 19 by the unsealing member 20 shown by the arrow D direction, the fixing point 18c is provided upstream of the opening 35.

For that reason, as reaction from the fixing point 18c, a force is applied in the arrow H direction of part (a) of FIG. 10. By the unsealing member 20, an unsealing force shown by the arrow D direction of part (a) of FIG. 10 is applied to the sealing member 19. At that time, between the fixing point 18c where the developer accommodating container 34 contacts the corner 18a3 of the head portion 18e2 of the fixing portion 18a and the force application portion 20a where the sealing member 19 contacts the corner 20e of the unsealing member 20, the developer accommodating container 34 is pulled in the arrow H direction of part (a) of FIG. 10. On the other hand, the sealing member 19 is pulled in the arrow D direction of part (a) of FIG. 10.

As a result, the sealing member 19 is peeled from the second bonding portion 22b, so that the peeling progresses in the arrow E direction of part (a) of FIG. 10. When the fixing point 18c is not provided at an upstream position with respect to the movement direction of the sealing member 19 with respect to the arrow D direction of part (a) of FIG. 10, an entirety of the developer accommodating member 37 is pulled in the arrow D direction in which the sealing member 19 is pulled by the unsealing member 20. For this reason, a force for peeling off the sealing member 19 from the second bonding portion 22b cannot be applied, so that the sealing member 19 cannot be peeled off of the sealing member 19. In this embodiment, with respect to the movement direction of the sealing member 19 shown by the arrow D direction of part (a) of FIG. 10, the fixing point 18c is provided at the upstream position, whereby the sealing member 19 can be reliably peeled off of the second bonding portion 22b.

### <Problem of Unsealing Property in Case of No Reinforcing Member>

Here, a comparison example in which it is difficult to peel off the sealing member 19 from the second bonding portion 22b will be described using FIGS. 17 to 19. Parts (a) and (b) of FIG. 17 are perspective views showing a structure of a developer accommodating member 37 during unsealing of a hard-to-unseal opening 35 provided in a developer accommodating container 34 in the comparison example. FIG. 18 is a sectional view showing a structure of a developing device 38 in the comparison example in which the opening 35 is hard to unseal. Parts (a) to (c) of FIG. 19 is partially sectional views showing a process of unsealing the hard-to-unseal opening 35 provided in the developer accommodating container 34 in the comparison example.

Part (b) of FIG. 19 shows a state in which in the comparison example in which the reinforcing member 41 is not provided at an overlapping position with the second bonding portion 22b, the sealing member 19 is intended to be peeled off of the second bonding portion 22b. Parts (a) and (b) of FIG. 17 show the comparison example in which the developer accommodating container 34 is provided with a single opening 35 and in which the reinforcing member 41 is not provided at the overlapping position with the second bonding portion 22b. Part (a) of FIG. 17 shows a state immediately before the sealing member 19 is peeled from the second bonding portion 22b, and part (b) of FIG. 17 and FIG. 18 show a state during peeling of the sealing member 19 from the second bonding portion 22b.

Parts (a) to (c) of FIG. 19 are sectional views showing a structure of the developer accommodating container 34 at a periphery of the opening 35 in the case where it became difficult to peel the sealing member 19 from the second bonding portion 22b in the comparison example in which the reinforcing member 41 is not provided at the overlapping position with the second bonding portion 22b of the developer accommodating container 34. In parts (a) to (c) of FIG. 19, the reinforcing member 41 is not provided at the overlapping position with the second bonding portion 22b of the developer accommodating container 34. Part (a) of FIG. 19 shows a state the unsealing of the opening 35 progresses to the second bonding portion 22b. From the state shown in part (a) of FIG. 19, when the unsealing member 20 is further rotated in the arrow C direction of part (b) of FIG. 19, the sealing member 19 is pulled and moved in the arrow D direction of part (b) of FIG. 19.

As shown in part (b) of FIG. 19, the reinforcing member 41 is not provided at the overlapping position with the second bonding portion 22b of the developer accommodating container 34. For this reason, the developer accommodating container 34 is pulled and moved in the arrow D direction of part (b) of FIG. 19 integrally with the sealing member 19 through the second bonding portion 22b at a periphery of the opening 35 without being peeled from the second bonding portion 22b.

For that reason, as shown in part (b) of FIG. 19, the opening 35 is largely opened in the arrow D direction. Further, as shown in part (c) of FIG. 19, the second bonding portion 22b is pulled by the sealing member 19, so that the opening 35 is deformed as shown in part (b) of FIG. 19. In this case, a force acting on the second bonding portion 22b is not in a positional relationship of inclination peeling as shown in part (a) of FIG. 10. The opening 35 is deformed as shown in part (b) of FIG. 19 and part (b) of FIG. 17. As a result, shearing peeling (peeling of approximately 0° in angle of the pulling direction relative to the second bonding portion 22b surface) is performed. For this reason, a large force is needed for peeling the sealing member 19 from the second bonding portion 22b.

Then, as shown in part (c) of FIG. 19, the developer accommodating container 34 is pulled in the arrow D direction of part (b) of FIG. 19 integrally with the sealing member 19 through the second bonding portion 22b at the periphery of the opening 35 while the sealing member 39 cannot be peeled from the second bonding portion 22b. Then, the opening 35 in the neighborhood of the second bonding portion 22b with respect to the longitudinal direction is further largely opened, so that the developer accommodating container 34 at the periphery of the opening 35 is wound about the outer periphery of the unsealing member 20.

Thus, the developer is accommodated in the deformable soft developer accommodating container 34 and the developer accommodating container 34 is deformed during unsealing of the opening 35. In that case, when the reinforcing member 41 is not provided at the overlapping position with the second bonding portion 22b of the developer accommodating container 34, it becomes difficult to pull the sealing member 19 from the second bonding portion.

### <Reinforcing Member>

Next, a structure of the reinforcing member 41 will be described using FIGS. 6, 7, 10, 20 and 21. Part (a) of FIG. 6 shows a state immediately before the peeling of the first bonding portion 22a which is peeled first from the sealing member 19. Part (b) of FIG. 6 and FIG. 10 show a state immediately before the peeling of the second bonding portion 22b after the peeling of the first bonding portion 22a and the widthwise third and fourth bonding portions 22c and 22d are ended and the opening 35 is exposed.

Part (a) of FIG. 20 is a sectional view showing a structure of the developer accommodating member 37 provided with the reinforcing member 41 on the inner surface side of the developer accommodating container 34. Part (b) of FIG. 20 is a partially enlarged view of part (a) of FIG. 20. Part (c) of FIG. 20 is a partially sectional view showing a structure of a peripheral portion of the opening 35 provided in the developer accommodating container 34. FIG. 21 is a perspective view for illustrating a length of the reinforcing member 41 in this embodiment with respect to the longitudinal direction.

The reinforcing member 41 provided at the overlapping position with the second bonding portion 22b of the developer accommodating container 34 performs a large function in an unsealing operation of the developer accommodating member 37. The reinforcing member 41 in this embodiment is constituted by a hard material having rigidity higher than the developer accommodating container 34. As the material of the reinforcing member 41, a resin material or a metallic material can be appropriately selected.

As described above, the case where the reinforcing member 41 is not provided at the overlapping position with the second bonding portion 22b of the developer accommodating container 34 will be considered. In that case, when the sealing member 19 is peeled from the second bonding portion 22b, as shown in part (b) of FIG. 17, the opening 35 of the flexible developer accommodating container 34 is deformed. For this reason, the sealing member 19 cannot be peeled from the second bonding portion 22b, so that it becomes difficult to unseal the opening 35.

In this embodiment, the reinforcing member 41 is provided at the overlapping position with the second bonding portion 22b of the developer accommodating container 34. As a result, when the sealing member 19 is peeled off of the second bonding portion 22b, deformation of the peripheral edge portion of the opening 35 and the second bonding portion 22b can be suppressed by the rigid reinforcing member 41. For this reason, in a state shown in part (a) of FIG. 10, the sealing member 19 can be peeled off of the second bonding portion 22b by the inclination peeling, so that the opening 35 can be unsealed with reliability.

Each of parts (a) to (c) of FIG. 7 shows an example in which the reinforcing member 41 is provided on an inner wall surface of the bottom 34a1 (the plane including the opening 35) of the molded portion 34a of the developer accommodating container 34 so as to overlap with the second bonding portion 22b as seen in a thickness direction of the bottom 34a1 shown by an arrow T direction. Parts (b) and (c) of FIG. 7 are enlarged views of a portion G in the neighborhood of the second bonding portion 22b shown in part (a) of FIG. 7 and each shows an example in which a relatively positional relationship between the reinforcing member 41 and the second bonding portion 22b is different from that in part (a) of FIG. 7.

### <Positional Relationship Between Reinforcing Member and Second Bonding Portion>

Next, the relatively positional relationship between the reinforcing member 41 and the second bonding portion 22b will be described using FIGS. 5, 7 and 10. In order to peel off the sealing member 19 from the second bonding portion 22b, as seen in the thickness direction of the bottom 34a1, including the opening 35, of the molded portion 34a shown by the arrow T direction of part (b) of FIG. 7, the positional relationship between the reinforcing member 41 and the second bonding portion 22b is required to be an overlapping relationship.

The reinforcing member 41 in this embodiment is long in the longitudinal direction (left-right direction of parts (a) and (b) of FIG. 5) of the developer accommodating container 34 as shown in parts (a) and (b) of FIG. 5, and is provided on a side opposite from the fixed portion 34a (fixing portion) of the developer accommodating container 34 with respect to the opening 35. Further, as seen in the thickness direction of the bottom 34a1 of the molded portion 34a including the opening 35 of the developer accommodating container 34, the second bonding portion 22a and the reinforcing member 41 is in a positional relationship in which the second bonding portion 22a and the reinforcing member 41 at least partially overlap with each other. The reinforcing member 41 and the second bonding portion 22b overlap with each other as seen in the arrow T direction.

As shown in part (a) of FIG. 10, an unsealing force is applied by pulling the sealing member 19 in the arrow D direction of part (a) of FIG. 10 by rotation of the unsealing member 20. At this time, the fixing point 18c of the developer accommodating container 34 contacting the corner 18a3 of the head portion 18a2 of the fixing portion 18a will be considered. Further, the force application portion 20a of the sealing member 19 contacting the corner 20e of the unsealing member 20 will be considered. Between the fixing point 18c and the force application portion 20a, the developer accommodating container 34 bonded to the second bonding portion 22b and the sealing member 19 are pulled in the arrow H direction and the arrow D direction, respectively, in part (a) of FIG. 10. The sealing member 19 is pulled off of the second bonding portion 22b by the inclination peeling in a state in which the sealing member 19 is folded back at the fold-back portion 19d.

Here, as shown in parts (a) and (b) of FIG. 20, the case where the reinforcing member 41 and the second bonding portion 22b do not overlap with each other as seen in the arrow T direction of part (b) of FIG. 20 will be considered. In that case, as shown in part (c) of FIG. 20, the bottom 34a1 is bent between the reinforcing member 41 and the second bonding portion 22b, and is pulled in the arrow D direction integrally with the sealing member 19 through the second bonding portion 22b.

As a result, the sealing member 19 is peeled from the second bonding portion 22b by the shearing peeling. For this reason, it becomes difficult to peel off the sealing member 19 from the second bonding portion 22b. Thus, in order to enable the peeling-off of the sealing member 19 from the second bonding portion 22b, as seen in parts (b) and (c) of FIG. 7, there is a need that the reinforcing member 41 and the second bonding portion 22b at least overlap with each other as seen in the arrow T direction of parts (b) and (c) of FIG. 7.

The reinforcing members 41 shown in parts (a) to (c) of FIG. 7 are examples in which the reinforcing members 41 are provided inside the developer accommodating container 34, but as shown in part (d) of FIG. 7, the reinforcing member 41 may also be provided outside the developer accommodating container 34, and the second bonding portion 22b may also be provided outside the reinforcing member 41. Incidentally, in the case where the sealing member 19 is peeled off of the first bonding portion 22a, the opening or the like is not provided between the fixing portion 18a and the first bonding portion 22a. For this reason, the developer accommodating container 34 pulled by the sealing member 19 through the first bonding portion 22a is not largely deformed. For this reason, even when the reinforcing member 41 is not provided at an overlapping position with the first bonding portion 22a of the developer accommodating container 34, an unsealing property of the opening 35 is not impaired.

### <Longitudinal Lengths of Opening, Reinforcing Member and Developer Accommodating Member>

Next, lengths of the opening 35, the reinforcing member 41 and the developer accommodating member 37 with respect to the longitudinal direction shown by the arrow F direction of FIG. 21 will be described using FIG. 21. A discharging property of the developer discharged through the opening 35 of the developer accommodating container 34 will be considered. Then, a length 35L of the opening 35 shown in FIG. 35 with respect to the longitudinal direction shown by the arrow F direction is required to be not less than ¼ of a length 34L of the bottom 34a1 of the molded portion 34a of the developer accommodating container 34 with respect to the longitudinal direction shown by the arrow F direction. At this time, a length 41L of the reinforcing member 41 with respect to the longitudinal direction shown by the arrow F direction may only be required to be appropriately selected depending on a sheet thickness or a material of the developer accommodating container 34.

The longitudinal length 35L of the opening 35 and the longitudinal length 41L of the reinforcing member 41 may be equal to each other or either one thereof may also be longer than the other length. Thus, the flexible developer accommodating container 34 in which the developer is accommodated and the developer accommodating member 37 including the sealing member 19 are provided with the reinforcing member 41 which overlaps with the second bonding portion 22b provided in the neighborhood of the edge portion of the opening 35 provided in the developer accommodating container 34. As a result, deformation of the opening 35 and the second bonding portion 22b can be suppressed until the sealing member 19 is peeled off of the second bonding portion 22b, so that the opening 35 can be unsealed with reliability.

According to this embodiment, the sealing member 19 sealing the opening 15 can be unsealed with reliability by providing an elongated single opening 35 along the longitudinal direction of the developer accommodating member 37 and by providing the reinforcing member 41 for reinforcing a portion in the neighborhood of the second bonding portion 22b provided in the neighborhood of the outer peripheral edge of the opening 35. Thus, the reinforcing member 41 is provided so as to overlap with the second bonding portion 22b provided at a periphery of the edge portion of the opening 35 of the developer accommodating container 34. As a result, the opening 35 can be unsealed with reliability. Further, the discharging property of the developer accommodated in the developer accommodating member 37 can be ensured.

In the case where the sealing member 19 is wound up by rotationally driving the unsealing member 20 by the unshown motor which is the driving source, there is no need for the user to remove the sealing member 19 as a toner seal by extracting the sealing member 19 from the developer accommodating member 37, so that the developing device 38 and the process cartridge A can be easily exchanged and used. Further, the sealing member 19 is fixed to the unsealing member 20, so that after the opening 35 is unsealed, the process cartridge A does not create a discarded material.

### <Other Reinforcing Members>

Other structures of the reinforcing member 41 in this embodiment will be described using FIGS. 22 and 23. Part (a) of FIG. 22 is a perspective view showing a structure of a developer accommodating member 37 provided with another reinforcing member 41 in this embodiment. Parts (b) to (e) of FIG. 22 are perspective views each showing a structure of another reinforcing member 41. Part (a) of FIG. 23 is a sectional view showing a structure of a developer accommodating member 37 provided with another reinforcing member 41 on an inner surface side of the developer accommodating container 34. Part (b) of FIG. 23 is a sectional view showing a structure of a developer accommodating member 37 provided with another reinforcing member 41 on an outer surface side of the developer accommodating container 34.

The reinforcing members 41 shown in parts (a) and (b) of FIG. 22 are constituted in a hollow rectangular shape enclosing a full circumference (all four sides) of the opening 35 by overlapping with the second bonding portion 22b. The reinforcing member 41 shown in part (c) of FIG. 22 is constituted in a channel shape (U-shape) such that the reinforcing member 41 overlaps with the second bonding portion 22a and the widthwise third and fourth bonding portions 22c and 22d, of the bonding portion 22.

The reinforcing member 41 shown in part (d) of FIG. 22 is constituted in a C-like shape such that the reinforcing member 41 overlaps with the second bonding portion 22b, the widthwise third and fourth bonding portions 22c and 22d, and both longitudinal end portions of the first bonding portion 22a, of the bonding portion 22.

The reinforcing member 41 shown in part (e) of FIG. 22 is constituted in a shape such that three reinforcing ribs 41b each extending toward the fixed portion 34d (fixing portion) at an intermediary portion of the reinforcing member 41 having the hollow rectangular shape shown in part (b) of FIG. 22.

Other reinforcing members 41 in this embodiment each includes, as shown in parts (a) to (e) of FIG. 22, at least a portion 41a provided on a side opposite from the fixed portion 34d (fixing portion) of the developer accommodating container 34 with respect to the opening 35. Further, each reinforcing member 41 is constituted by including a portion 41b extending from the portion 41a toward the fixed portion 34d (fixing portion). The reinforcing members 41 shown in parts (b) and (e) of FIG. 22 further includes a portion 41c provided on a side opposite from the portion 41a and connected with the portion 41b. The reinforcing member 41 shown in part (d) of FIG. 22 is provided with a portion 41d extended from an associated portion 41b, provided at each of both end portions of the portion 41a, toward a longitudinal center.

### <Discharging Operation of Developer>

A constitution in which the developer in the developer accommodating container 34 is discharged through the opening 35 will be described using FIGS. 9 to 13, 24 and 25. The bottom 34a1 of the molded portion 34a of the developer accommodating container 34 is struck by the urging sheet 21b, which is an urging member, at a predetermined interval with rotation of the unsealing member 20.

FIGS. 12 and 13 are sectional views each showing a structure of the developing device 38 in this embodiment.

Part (a) of FIG. 24 is a sectional view showing a state in which an urging member 20h does not urge the developer accommodating container 34 in the comparison example in which the developer accommodating container 34 is not provided with the reinforcing member 41. Part (b) of FIG. 24 is a sectional view showing a state in which the urging member 20h urges the developer accommodating container 34 in the comparison example in which the developer accommodating container 34 is not provided with the reinforcing member 41. Part (c) of FIG. 24 is a sectional view showing a state in which the urging member 20h does not urge the developer accommodating container 34 in the case where the reinforcing member 41 is provided on the inner surface side of the developer accommodating container 34 in this embodiment.

Part (d) of FIG. 24 is a sectional view showing a state in which an urging member 20h urges the developer accommodating container 34 in the case where the reinforcing member 41 is provided on the inner surface side of the developer accommodating container 34 in this embodiment. Part (e) of FIG. 24 is a sectional view showing a state in which the urging member 20h does not urge the developer accommodating container 34 in the case where another reinforcing member 41 is provided on the inner surface side of the developer accommodating container 34. Part (f) of FIG. 24 is a sectional view showing a state in which another urging member 20h urges the developer accommodating container 34 in the case where the reinforcing member 41 is provided on the inner surface side of the developer accommodating container 34 in this embodiment.

Part (a) of FIG. 25 is a sectional view showing motion of a periphery of the opening 35 with rotation of the urging member 20h in the comparison example in which the developer accommodating container 34 is not provided with the reinforcing member 41. Part (b) of FIG. 25 is a sectional view showing motion of a periphery of the opening 35 with rotation of the urging member 20h in the case where the reinforcing member 41 is provided on the inner surface side of the developer accommodating container 34 in this embodiment. Part (c) of FIG. 25 is a sectional view showing motion of a periphery of the opening 35 with rotation of the urging member 20h in the case where another reinforcing member 41 is provided on the inner surface side of the developer accommodating container 34.

### <Urging Member>

As shown in FIG. 12, the unsealing member 20 also has a function as the urging member. On an outer peripheral surface of the unsealing member 20, the urging sheet 21b which is the urging member is fixed by an engaging portion 20i. As shown in FIGS. 12 and 13, the urging sheet 21b is rotated in the arrow C direction of FIGS. 12 and 13 integrally with the unsealing member 20. After the developer accommodated in the developer accommodating container 34 is discharged through the opening 35, the urging sheet 21b also has a function of feeding the developer toward the supplying roller 23 and the developing roller 13 while stirring the developer in the developing chamber 4.

<Behavior of Developer from Before Unsealing of Opening to Time of Start of Unsealing>

Next, behavior of the developer from before the unsealing of the opening 35 to the time of a start of the unsealing will be described using FIG. 9. When from a state before the unsealing of the opening 35 shown in part (a) of FIG. 9, the unsealing member 20 is rotated in the arrow C direction of part (b) of FIG. 9, the sealing member 19 is pulled in the arrow D direction of part (b) of FIG. 9 by the force application portion 20a where the sealing member 19 contacts the corner 20c of the unsealing member 20.

On the other hand, the developer accommodating container 34 receives the resistance in the arrow H direction of part (b) of FIG. 9 by the fixing point 18c where the developer accommodating container 34 contacts the corner 18a3 of the head portion 18a2 of the fixing portion 18a fixed to the frame 18, and thus is supported at the fixing point 18c. For that reason, at the time of the unsealing of the opening 35, three portions consisting of the force application portion 20a, the fixing point 18c and a portion where the sealing member 19 is peeled off of the second bonding portion 22a will be considered. These three portions are, as shown in FIG. 14, moved to positions where these three portions are arranged on a rectilinear line of the plane N3 extending along the arrow D direction of FIG. 14 in which the sealing member is pulled, in a cross-section perpendicular to the rotation axis 20g of the unsealing member 20.

A position of the opening 35 shown in part (a) of FIG. 9 before performing the unsealing operation by applying a pulling force to the sealing member 19 by the rotation of the unsealing member 20 will be considered. Further, a position of the opening 35 shown in part 8b) of FIG. 9 when the unsealing operation of the opening 35 is started and the sealing member 19 is peeled from the first bonding portion 22a will be considered. The positions of the opening 35 in the respective states change. As a result, stagnation of the developer in the neighborhood of the opening 35 can be prevented, so that a good discharging property of the developer through the opening 35 is achieved.

### <Discharging Operation of Developer After Unsealing of Opening.

A discharging operation of the developer after the unsealing of the opening 35 will be described using FIGS. 9 to 11. The opening 35 is unsealed by peeling off the sealing member 19 from the bonding portion 22 as shown in part (c) of FIG. 9, part (a) of FIG. 10 and part (b) of FIG. 10 in a named order. In a state in which the developer accommodating member 37 is mounted in the image forming apparatus B, the opening 35 provided in the bottom 34a1 of the molded portion 34a of the developer accommodating container 34 is disposed so as to open downwardly. For this reason, the developer in the neighborhood of the opening 35 is discharged through the opening 35 by the action of gravitation of the developer itself and by vibration or the like of the developer accommodating container 34 when the sealing member 19 is peeled off of the bonding portion 22 during the unsealing operation of the opening 35.

After the unsealing of the opening 35, when the unsealing member 20 is further rotated in the arrow C direction, also the urging sheet 21b fixed to the unsealing member 20 is also rotated in the arrow C direction integrally with the unsealing member 20. At this time, as shown in FIG. 11, the flexible urging sheet 21b is pushed back by the developer in the neighborhood of the bottom 34a1 of the molded portion 34a of the developer accommodating container 34. Then, the urging sheet 21b pushes back the bottom 34a1 of the molded portion 34a of the developer accommodating container 34 by an elastic force thereof while being wound about the outer periphery of the unsealing member 20.

At this time, the urging sheet 21b has elasticity, and therefore, is likely to be restored to an original shape. By this restoring force, the urging sheet 21b pushes the developer in the developer accommodating container 34 in the arrow J direction as shown in FIG. 12. When the bottom 34a1 of the molded portion 34a of the developer accommodating container 34 is pushed in the arrow J direction of FIG. 12, the developer accommodating container 34 is pushed against the frame 18 through the developer, so that an entirety of the developer accommodating container 34 is deformed.

Further, an inside volume of the developer accommodating container 34 is decreased by being pushed by the urging sheet 21b. Thus, the developer in the developer accommodating container 34 is stirred by the decrease in volume of the developer accommodating container 34 and by a change in an entire shape of the developer accommodating container 34. As a result, the developer is easily discharged through the opening 35. At this time, a portion of the developer accommodating container 34 other than the opening 35 is closed, so that there is no escape route of the developer except for the opening 35. For that reason, the discharging property of the developer through the opening 35 is good. By such a discharging action, the developer is easily discharged in the arrow C direction of FIG. 12 through the opening 35.

Incidentally, when at least a point of the developer accommodating container 34 is contacted to and pressed against the frame 18 by being pushed by the urging sheet 21b, the developer accommodating container 34 can be deformed. Further, by making a rotational axis direction of the developing roller 13 and the longitudinal direction of the opening 35 parallel to each other, the developer discharged into the developing chamber 4 through the opening 35 is easily supplied over an entirety of the longitudinal direction of the developing roller 13 with no localization. Further, when the developing device 38 is mounted in the image forming apparatus B, the opening 35 is provided so as to open toward the direction of gravitation. As a result, the discharging property of the developer discharged through the opening 35 can be improved.

FIGS. 24 and 25 show examples each in the case where a part of the unsealing member 20 is provided with a rigid urging member 20h. Parts (a) and (b) of FIG. 24 and part (a) of FIG. 25 show the comparison example in which the reinforcing member 41 is not provided. Parts (c) to (f) of FIG. 24 and parts (b) and (c) of FIG. 25 each shows a constitution of this embodiment in which the reinforcing member 41 is provided. In these figures, motion of the developer accommodated in the developer accommodating container 34 at a periphery of the opening 35 is compared between the case where the reinforcing member 41 is provided and the case where the reinforcing member 41 is not provided.

Compared with the case where the reinforcing member 41 is not provided as shown in parts (a) and (b) of FIG. 24 and part (a) of FIG. 25, in the case where the reinforcing member 41 is provided as shown in parts (c) to (f) of FIG. 24 and parts (b) and (c) of FIG. 25, a deformation range of the developer accommodating container 34 at the periphery of the opening 35 increases. For this reason, compared with the case where the reinforcing member 41 is not provided, the discharging property of the developer discharged through the opening 35 is good, so that an effect of improving the discharging property of the developer discharged through the opening 35 is achieved by the presence of the reinforcing member 41.

Parts (a) to (e) of FIG. 22, parts (a) and (b) of FIG. 23, parts (e) and (f) of FIG. 24 and part (c) of FIG. 25 each shows an example in which the reinforcing member 41 is constituted by being extended in the direction of the first bonding portion 22a. Thus, in the case where the reinforcing member 41 is expanded to a region in the neighborhood of the first bonding portion 22a, as shown in parts (e) and (f) of FIG. 24 and part (c) of FIG. 25, also the developer in the neighborhood of a full circumference (all four sides) of the opening 35 can be reliably moved by the rotation of the unsealing member 20. As a result, the discharging property of the developer discharged through the opening 35 is further improved.

Incidentally, a size and a shape of the reinforcing member 41 may only be required to be appropriately set in conformity to a desired discharging amount of the developer when the developer accommodated in the developer accommodating container 34 is discharged through the opening 35. For example, various shapes such as frame shapes or portal shapes as shown in parts (b) to (e) of FIG. 22 may only be required to be appropriately selected. Further, as shown in part (b) of FIG. 23, the reinforcing member 41 may also be provided outside the bottom 34a1 of the molded portion 34a of the developer accommodating container 34, and a mounting position thereof may only be required to be appropriately selected in conformity to a manufacturing convenience.

Further, the developer accommodating member 37 is provided inside the frames 17 and 18, the developer accommodating container 34 is urged so as to be pressed against the frame 18 by urging the bottom 34a1 of the molded portion 34a of the developer accommodating container 34 with the urging member 20h or the urging sheet 21b, which rotates integrally with the unsealing member 20. As a result, the discharging property of the developer discharged through the opening 35 can be improved.

Further, a base material of the sealing member 19 is also constituted by polyethylene terephthalate (PET), polyethylene (PE), polypropylene (PP), or the like. As the sealing member 19, a flexible sheet having a thickness of 0.03 mm-0.15 mm is used. For this reason, similarly as in the urging sheet 21b, the sealing member 19 rotates integrally with the unsealing member 20 and urges the bottom 34a1 of the molded portion 34a of the developer accommodating container 34, so that the discharging property of the developer discharged through the opening 35 can be improved.

### <Shape Restoring Operation of Developer Accommodating Container>

From a state in which the opening 35 is unsealed as shown in FIG. 12, the unsealing member 20 is further rotated in the arrow C direction, so that as shown in FIG. 13, the urging sheet 21b is spaced from the bottom 34a1 of the molded portion 34a of the developer accommodating container 34. The developer accommodating container 34 has flexibility. For this reason, by the gravitation of the developer itself accommodated in the developer accommodating container 34, the bottom 34a1 of the molded portion 34a of the developer accommodating container 34 is pushed back in the arrow K direction of FIG. 13 and is likely to be restored to a state thereof before being urged by the urging sheet 21b.

As shown in FIG. 13, when the unsealing member 20 is further rotates in the arrow C direction from the state in which the shape of the developer accommodating container 34 is restored to the original state, the urging sheet 21b is also rotated integrally with the unsealing member 20. Then, as shown in FIG. 12, the bottom 34a1 of the molded portion 34a of the developer accommodating container 34 is pushed in the arrow J direction by the urging sheet 21b and thus the developer accommodating container 34 is pressed against the frame 18, so that the developer accommodating container 34 is deformed. As a result, the developer at a position other than the position in the neighborhood of the opening 35 is also moved, so that the discharging property of the developer discharged through the opening 35 is improved.

### <Repeating Operation of Unsealing and Restoration of Developer Accommodating Container>

In the case where the developer remains in a large amount in the developer accommodating container 34 immediately after the opening 35 is unsealed, an entering amount of the urging sheet 21b into the developer accommodating container 34 changes repetitively. As a result, the urging sheet 21b deforms the developer accommodating container 34 so that the developer accommodating container 34 is pressed against the frame 18. Contraction and restoration of the developer accommodating container 34 are repeated by repeating the unsealing of the developer accommodating container 34 with the urging sheet 21b and restoration of the shape of the developer accommodating container 34 by the weight of the developer in the developer accommodating container 34.

As a result, the developer accommodating container 34 vibrates since the developer accommodating container 34 itself moves, and by this vibration, the developer in the developer accommodating container 34 is loosened, so that the discharging property of the developer discharged through the opening 35 is improved. The unsealing member 20 is rotated in the arrow C direction, and therefore, the developer accommodating container 34 can be repetitively urged by the urging sheet 21b. The urging sheet 21b provided on the unsealing member 20 also functions as the urging member, and therefore, the number of component parts is reduced, so that cost reduction can be realized.

Thus, the developer in the developer accommodating container 34 can be satisfactorily discharged without providing another discharging component part such as a developer discharging roller or the like in the neighborhood of the opening 35, so that agglomeration and bridge of the developer in the neighborhood of the opening 35 can be prevented. When the process cartridge A is kept in a certain attitude without being used for a long term when the process cartridge A is transported, stored or the like, tapping such that the developer in the developer accommodating container 34 is localized to one side and is agglomerated occurs. Even when the developer is agglomerated by the tapping, the agglomeration of the developer can be loosened by the vibration of the developer accommodating container 34 and by the movement of the opening 35, so that it is possible to prevent a state in which it becomes possible to discharge the developer.

### <Circulating Operation of Developer in Developer Accommodating Container by Urging Member>

Next, a circulating operation of the developer in the developer accommodating container 34 by the urging sheet 21b will be described using FIGS. 12 and 13. As shown in FIG. 13, the rotation of the unsealing member 20 progresses, so that the urging sheet 21b is spaced from the developer accommodating container 34. At this time, the developer accommodating container 34 has flexibility, and therefore, is pushed back in the arrow K direction by the weight of the developer accommodated in the developer accommodating container 34 and is likely to be restored to the state before the developer accommodating container 34 is urged by the urging sheet 21b.

When the unsealing member 20 is further rotated in the arrow C direction, the urging sheet 21b is also rotated integrally with the unsealing member 20, so that as shown in FIG. 12, the urging sheet 21b urges the bottom 34a1 of the molded portion 34a of the developer accommodating container 34 in the arrow J direction, and thus the developer accommodating container 34 is pressed against the frame 18. As a result, the developer at the position other than the position in the neighborhood of the opening 35 is also moved by the deformation of the developer accommodating container 34. By motion of the developer as described above, a circulating action of the developer in the developer accommodating container 34 occurs. That is, the developer in the developer accommodating container 34 is moved by the deformation of the developer accommodating container 34. As a result, the developer in the developer accommodating container 34 is circulated. At this time, an amplitude when the developer accommodating container 34 is deformed and a degree of the circulating action are in a proportional relationship.

### Second Embodiment

Next, with reference to (a) of FIGS. 26 and 27, a developer accommodating unit according to the present invention in a constitution in this embodiment will be described. Incidentally, constituent elements similar to those in the above-described First Embodiment will be omitted from description by adding the same reference numerals or symbols or by adding the same member (portion) names even when the reference numerals or symbols are different from those in First Embodiment. Part (a) of FIG. 26 is a perspective view showing a structure of a developer accommodating member 377 provided with reinforcing members 42 in this embodiment. Part (b) of FIG. 26 is a perspective view showing a structure of the reinforcing member 42 of part (a) of FIG. 26.

Part (c) of FIG. 26 is a perspective view showing a structure of a developer accommodating member 37 provided with a single reinforcing member 42 shown in part (b) of FIG. 26. Part (a) of FIG. 27 is a sectional view showing a structure of a developer accommodating member 37 provided with another reinforcing member 42 in this embodiment on an inner surface side of the developer accommodating container 34. Part (b) of FIG. 27 is a sectional view showing a structure of a developer accommodating member 37 provided with another reinforcing member 42 in this embodiment on an outer surface side of the developer accommodating container 34.

FIGS. 26 and 27 each shows an example of the reinforcing member 42 in this embodiment. The reinforcing member 42 shown in part (a) of FIG. 26 are not provided over an entire region of the second bonding portion 22b with respect to the longitudinal direction shown by the arrow F direction of part (a) of FIG. 26. With respect to the longitudinal direction of the second bonding portion 22b shown by the arrow F direction of part (a) of FIG. 26, the reinforcing members 42 are provided only at portions where reinforcing of the opening 35 is needed during unsealing of the opening 35.

The reinforcing members 42 in this embodiment are provided on a side opposite from the fixed portion 34d (fixing portion) of the developer accommodating container 34 with respect to the opening 35. Further, each of the reinforcing members 42 includes a portion 42b where the second bonding portion 22b and each of the reinforcing members 42 at least partially overlap with each other. Each of the reinforcing members 42 further includes an extended portion 42c which is a portion extended from the portion 42b in a direction opposite to the fixed portion 34d (fixing portion).

In this embodiment, with respect to the longitudinal direction of the opening 35 shown by the arrow F direction of part (a) of FIG. 26, the reinforcing member 42 are disposed at three positions. Each of the reinforcing members 42 includes, as shown in part (a) of FIG. 27, the portion 42b overlapping with the second bonding portion 22b as seen in the arrow T direction which is a thickness direction of the bottom 34a1 of the molded portion 34a of the developer accommodating container 34. Each of the reinforcing member 42 further includes the extended portion 42c extended from the portion 42b overlapping with the second bonding portion 22b to an overlapping position with the first bonding portion 22a as seen in the arrow T direction so as to extend substantially one full circumference along an inner wall surface of the developer accommodating container 34.

The extended portion 42c of the reinforcing member 42 is a portion other than the portion 42b overlapping with the second bonding portion 22b. When the sealing member 19 is peeled off of the second bonding portion 22b, motion of the portion 42b overlapping with the second bonding portion 22b is suppressed by the extended portion 42c. Each of the reinforcing members 42 is disposed so that the extended portion 42c reaches the neighborhood of the first bonding portion 22a or the fixed portion 34d. As a result, when the sealing member 19 is peeled off the second bonding portion 22b, motion of an entirety of the reinforcing members 42 can be suppressed.

Incidentally, as shown in part (a) of FIG. 26, with respect to the longitudinal direction of the opening 35 shown by the arrow F direction, the reinforcing members 42 are provided at the three positions. As another example, as shown in part (c) of FIG. 26, with respect to the longitudinal direction of the opening 35 shown by the arrow F direction, a single reinforcing member 42 may also be provided at a position. The number of reinforcing members 42 to be provided and an arrangement position of the reinforcing members 42 with respect to the longitudinal direction of the opening 35 shown by the arrow F direction can be appropriately set in conformity to strength of the reinforcing members 42 and peeling strength of the second bonding portion 22b.

Further, as shown in part (a) of FIG. 27, the reinforcing member(s) 42 may be provided inside the developer accommodating container 34. As another example, as shown in part (b) of FIG. 27, the reinforcing member(s) 42 may also be provided outside the developer accommodating container 34. The reinforcing member 42 shown in part (b) of FIG. 27 includes a portion 42 overlapping with the second bonding portion 22b. The reinforcing member 42 further includes an extended portion 42c extended from the portion 42b to a crossing position between the bottom 34a1 of the molded portion 34a and the air-permeable portion 34b so as to extend substantially one full circumference along an outer wall surface of the developer accommodating container 34. Other constitutions are the same as those in First Embodiment, and a similar effect can be obtained.

### Third Embodiment

Next, with reference to (a) of FIGS. 28 and 34, a developer accommodating unit according to the present invention in a constitution in this embodiment will be described. Incidentally, constituent elements similar to those in the above-described embodiments will be omitted from description by adding the same reference numerals or symbols or by adding the same member (portion) names even when the reference numerals or symbols are different from those in the above-described embodiments.

FIG. 28 is a perspective view showing a structure of a developer accommodating member 37 in this embodiment. FIG. 29 is a partially sectional view showing a structure of a peripheral portion of an opening 35 of a developer accommodating container 34 in this embodiment. Parts (a) and (b) of FIG. 30 are partially sectional views showing a process of unsealing the opening 35 provided in the developer accommodating container 34 in this embodiment. Parts (a) and (b) of FIG. 31 are partially sectional views showing the process of unsealing the opening 35 provided in the developer accommodating container 37 in this embodiment. FIG. 32 is a perspective view showing a structure of another developer accommodating container in Third Embodiment in which strength of a reinforcing portion is enhanced. FIG. 33 is a perspective view showing a structure of still another developer accommodating container 34 in this embodiment in which a reinforcing portion 34e is provided with an adhesive 34f FIG. 34 is a sectional view showing a structure of a further developer accommodating member 37 in this embodiment in which a state that a reinforcing portion 34e is bonded to an inner wall surface of a frame 18 of a developing device 38 with an adhesive 34f is formed.

The developer accommodating member 37 in this embodiment is not provided with the reinforcing members 41 and 42 used in the above-described embodiments. Instead thereof, the reinforcing portion 34e is provided by partially increasing a thickness of the collar portion 34c, of the molded portion 34a of the developer accommodating container 34, where the fixed portion 34d of the developer accommodating container 34 fixed to the fixing portion 18a provided on the frame 18. Further, in this embodiment, the unsealing direction shown by the arrow E direction of FIG. 14 in which the opening 35 is unsealed by peeling off the sealing member 19 from the bonding portion 22 as described above with reference to FIG. 14 is reversed as an unsealing direction shown by an arrow X direction of FIG. 29.

### <Reinforcing Portion>

As shown in FIG. 28, the collar portion 34c of the molded portion 34a of the developer accommodating container 34 in provided with the fixed portion 34d. A downstream end portion of the fixed portion 34d with respect to the unsealing direction shown by the arrow X direction of FIG. 28 in which the opening 35 is unsealed by peeling off the sealing member 19 from the bonding portion 22 at the fixed portion 34d will be considered. A region ranging along the unsealing direction from the downstream end portion of the fixed portion 34d to an upstream end portion of the second bonding portion 22b with respect to the unsealing direction is indicated by P.

A region between outer ends of the third and fourth bonding portions 22c and 22d with respect to the longitudinal direction of the opening 35 shown by the arrow F direction of FIG. 28 is indicated by W. The thickness of the collar portion 34c in a region enclosed by the regions P and W shown in FIG. 28 is set at a value thicker than thicknesses of other portions, so that the reinforcing portion 34e is provided.

On a direction upstream of the sealing member 19 with respect to the unsealing direction shown by the arrow X direction of FIG. 29, the first bonding portion 22a is provided. Further, on a side downstream of the sealing member with respect to the unsealing direction shown by the arrow X direction of FIG. 29, the second bonding portion 22b is provided. Further, along the unsealing direction of the sealing member 19 shown by the arrow X direction of

FIG. 28, the third and fourth bonding portions 22c and 22d connecting longitudinal end portions of the first bonding portion 22a and the second bonding portion 22b are provided.

The region P ranging from the downstream end portion of the fixed portion 34d (fixing portion) to the upstream end portion of the second bonding portion arrow X direction of FIG. 28 will be considered. Further, the region W between the outside ends of the third and fourth bonding portions 22c and 22d with respect to the longitudinal directions of the developer accommodating container 34 shown by the arrow F direction of FIG. 28 will be considered. Further, in the region enclosed by the regions P and W, the reinforcing portion 34e is provided.

The thickness of the reinforcing portion 34e is set at a value thicker than thicknesses of other portions of the developer accommodating container 34 provided with the opening 35. By providing the reinforcing portion 34e, strength against an unsealing load when the opening 35 is unsealed by peeling off the sealing member 19 from the bonding portion 22 can be ensured. The thickness of the reinforcing portion 34e may be appropriately selected depending on the unsealing load.

In this embodiment, the molded portion 34a of the developer accommodating container 34 is prepared by vacuum molding (forming). As a result, a basic thickness of the material of the developer accommodating container 34 is set at a thickness in which the reinforcing portion 34e has necessary strength against the unsealing load. In the vacuum molding, the material is molded by being elongated. As a result, portions other than the reinforcing portion 34e can be set at thicknesses thinner than the thickness of the reinforcing portion 34e. An entirety of the collar portion 34c of the molded portion 34a of the developer accommodating container 34 may also be formed as a thick portion. As a result, the thick portion can be provided while including the reinforcing portion 34e enclosed by the regions P and W shown in FIG. 28.

The reinforcing portion 34e comprising the thick portion may only be required to cover at least the region enclosed by the regions P and W shown in FIG. 28, and the region may be appropriately selected. As regards the necessary strength of the molded portion a of the developer accommodating container 34, strength of the region defined as the reinforcing portion 34e provided at the collar portion 34c of the molded portion 34a has precedence over those of other portions, but the strengths of other portions can be appropriately selected.

### <Welded Region of Molded Portion>

A welded region of the sealing member 19 to the molded portion 34a will be described using FIGS. 28 and 29.

### <Sealing Member>

As shown in FIGS. 28 and 29, the sealing member 19 seals up the developer accommodated in the developer accommodating container 34 by covering the opening 35 of the developer accommodating container 34 before use of the process cartridge A. The sealing member 19 is moved by being wound up about an outer periphery of the unsealing member 20 rotating in the arrow C direction and thus is peeled off of the bonding portion 22, so that the opening 35 is exposed.

The sealing member 19 is constituted in a sheet shape including a sealing portion 19a covering the opening 35 of the developer accommodating container 34, a portion-to-be-engaged 19b comprising a through hole and fixed to the engaging portion 20b of the unsealing member 20, and a connecting portion 19c connecting the sealing portion 19a and the portion-to-be-engaged 19b.

### <Portion-to-be-Engaged of Sealing Member>

The sealing member 19 has a sheet shape and is provided with a free end portion 19e an upstream end side with respect to the unsealing direction shown by the arrow X direction of FIG. 29, and the free end portion 19e is provided with the portion-to-be-engaged 19b comprising a through hole. The portion-to-be-engaged 19b is engaged by being fitted with a shaft portion 20b1 of an engaging portion 20b provided on the unsealing member 20.

### <Connecting Portion of Sealing Member>

A portion connecting the sealing portion 19a and the portion-to-be-engaged 19b fixed to the engaging portion 20b provided on the unsealing member 20 is the connecting portion 19c. The connecting portion 19c is a portion receiving a force from the unsealing member 20 and transmitting the force so as to peel off the sealing portion 19a from the bonding portion 22.

### <Bonding Between Sealing Member and Molded Portion of Developer Accommodating Container>

Bonding between the sealing member 19 and the molded portion 34a of the developer accommodating container 34 will be described using FIG. 29. In this embodiment, as shown by the arrow X direction of FIG. 29, the opening 35 is unsealed in the direction opposite to the unsealing direction shown by the arrow E direction of FIG. 14 in the above-described embodiments. The second bonding portion 22b in this embodiment is disposed on the downstream side of the unsealing direction shown by the arrow X direction of FIG. 29 and on the fixed portion 34d side of the developer accommodating container 34. The third bonding portion 22b in this embodiment is disposed on the collar portion 34c of the developer accommodating container 34.

On the other hand, the first bonding portion 22a is disposed on a side opposites from the second bonding portion 22b with respect to the opening 35. The first bonding portion 22a and the second bonding portion 22b are continuously connected by the third and fourth bonding portions 22c and 22d and are constituted as the bonding portion 22 having a hollow rectangular shape. The bonding portion 22 is provided in the neighborhood of the peripheral edge of the opening 35, and the sealing member 19 peelably bonded to the bonding portion 22 and thus covers the opening 35 with no gap. As a result, the developer accommodated in the developer accommodating member 37 is prevented from flowing out of the developer accommodating member 37 through the opening 35.

### <Fold-Back Portion of Connecting Portion of Sealing Member>

A structure of the fold-back portion 19d provided as a part of the connecting portion 19c of the sealing member 19 will be described using FIG. 29.

As shown in FIG. 29, at the instant when the opening 35 is unsealed by peeling off the sealing member 19 from the first bonding portion 22a, a plane passing through the first bonding portion 22a and parallel to the plane including the opening 35 is M1. Further, a plane perpendicular to the plane M1 and passing through the first bonding portion 22a is M2.

Here, the force application portion 20a of the sealing member 19 contacting the corner 20d of the unsealing member 20 is disposed on a side closer to the second bonding portion 22b than the plane M2 passing through the first bonding portion 22a is. That is, when the sheet-shaped sealing member 19 is seen along a surface thereof, at the connecting portion 19c between the first bonding portion 22a and the portion-to-be-engaged 19b fixed to the engaging portion 20b of the unsealing member 20, a fold-back portion 19d is provided.

A plane parallel to the surface of the sealing member 19 connecting the force application portion 20a and the fold-back portion 19d of the sealing member 19 along a pulling direction shown by the arrow D direction in which the sealing member 19 is pulled is M3. An angle of the fold-back portion 19 where the planes M3 and M1 cross each other and which is not an obtuse angle is 02.

In order to unseal the opening 35 by peeling off the sealing member 19 from the first bonding portion 22a with a proper force, the angle θ2 of the fold-back portion 19d of the sealing member 19 may preferably be 90° or less.

### <Easy-to-Peeling Property of Sealing Member>

Next, a method of setting a peeling force, for peeling off the sealing member 19 from the bonding portion 22, at a desired value will be described. In this embodiment, in order to set the peeling force for peeling off the sealing member 19 from the bonding portion 22 at the desired value (in this embodiment, a force which is an small as possible within a range in which a developer sealing property can be maintained), two methods are principally employed.

### <First Method>

A first method is the same as that in First Embodiment, and therefore, redundant description will be omitted.

### <Second Method>

A second method is such that as shown in FIG. 29, when the sealing member 19 is peeled off of the first bonding portion 22a, the arrow D direction in which the sealing member 19 is pulled by a pulling force obtained at the force application portion 20a of the sealing member 19 contacting the corner 20d of the unsealing member 20 will be considered. Further, the arrow X direction in which the unsealing of the opening 35 of the developer accommodating container 34 progresses will be considered. Further, the angle θ2 formed between the arrow D direction and the arrow X direction is set at 90° or less.

The bottom 34a1 of the molded portion 34a of the developer accommodating container 34 and the sealing member 19 will be considered. The bottom 34a1 and the sealing member 19 are in a positional relationship of inclination peeling in which the angle θ2 between the plane M1 parallel to the bonding portion 22 surface of the developer accommodating container 34 and the plane M3 along the arrow D direction in which the sealing member 19 is pulled is 90° or less. In the inclination peeling, it has been known that a peeling force necessary to peel off the bottom 34a1 and the sealing member 19 can be reduced.

Thus, with respect to the arrow X direction in which the unsealing of the unsealing member 19 progresses, the sealing member 19 is placed in a folded-back state at the fold-back portion 19d, whereby the surface of the first bonding portion 22a and the sealing member 19 are in the positional relationship of the inclination peeling, so that the peeling force can be reduced. Here, in a state in which the sealing member 19 is peeled off the widthwise third and fourth bonding portions 22c and 22d disposed in parallel to the unsealing direction of the sealing member 19 along the arrow X direction, the angle θ2 of the fold-back portion θ2 is not necessarily be required to be 90° or less.

The inclination peeling in which the angle θ2 between the surface along the direction in which the sealing member 19 is pulled and the surface of the bonding portion 22 is 90° or less is carried out. This is a necessary condition when the sealing member 19 is peeled off of each of the first and second bonding portions 22a and 22b which are disposed along the longitudinal direction perpendicular to the unsealing direction of the sealing member 19.

### <Unsealing Operation of Sealing Member>

An unsealing operation for peeling off the sealing member 19 from the first bonding portion 22a will be described using FIG. 30. As shown in part (a) of FIG. 30, a rotational driving force of an unshown motor which is a driving source is transmitted to the unsealing member 20, so that the unsealing member 20 is rotated in the arrow C direction. When the rotation of the unsealing member 20 progresses, the sealing member 19 wound up about the outer periphery of the unsealing member 20 is pulled in the arrow D direction of part (a) of FIG. 30 and is in a state immediately before a start of the unsealing of the first bonding portion 22a as shown in part (a) of FIG. 30.

With the rotation of the unsealing member 20, the sealing member 19 fixed at the portion-to-be-engaged 19b thereof to the engaging portion 20b of the unsealing member 20 is pulled in the arrow D direction by the force application portion 20a of the sealing member 19 contacting the corner 20d of the unsealing member 20 having a square shape in cross-section. When the sealing member 19 is pulled in the arrow D direction, the developer accommodating container 34 is pulled in the arrow D direction through the first bonding portion 22a. At this time, in the developer accommodating container 34, the developer is filled. As a result, the shape of the developer accommodating container 34 is maintained by the developer accommodated in the developer accommodating container 34, whereby resistance shown by the arrow H direction against the first bonding portion 22a pulled in the arrow D direction generates.

Here, by setting the angle θ2 of the fold-back portion 19d at 90° or less, the sealing member 19 is peeled off of the first bonding portion 22a in the arrow D direction through the inclination peeling. As shown in part (b) of FIG. 30, when the sealing member 19 is peeled off of the first bonding portion 22a, the opening 35 is unsealed.

Next, a peeling operation for peeling off the sealing member 19 from the second bonding portion 22b will be described using FIG. 31. From the state shown in part (b) of FIG. 30, the sealing member 19 is further rotated in the arrow D direction.

Part (a) of FIG. 31 shows a state immediately before peeling off of the sealing member 19 from the second bonding portion 22b is started by pulling of the sealing member 19 in the arrow D direction through further rotation of the unsealing member 20 in the arrow C direction.

With rotation of the unsealing member 20, the sealing member 19 locked and fixed at the portion-to-be-engaged 19b by the engaging portion 20b of the unsealing member 20 is pulled in the arrow D direction of part (a) of FIG. 3 by the force application portion 20a where the sealing member 10 contacts the corner 20e of the unsealing member 20 having the square shape in cross-section. Then, when the sealing member 19 is pulled in the arrow D direction of part (a) of FIG. 31, the developer accommodating container 34 is pulled in the arrow D direction of part (a) of FIG. 31 through the second bonding portion 22b. At this time, the reinforcing portion 34e provided at the collar portion 34c of the molded portion 34a of the developer accommodating container 34 has strength against the unsealing force for pulling the second bonding portion 22b in the arrow D direction of part (a) of FIG. 31. As a result, resistance in an arrow V direction of part (a) of FIG. 31 is generated in the second bonding portion 22b pulled in the arrow D direction of part (a) of FIG. 31.

Here, as shown in part (a) of FIG. 31, an angle θ3 of the fold-back portion 19d of the sealing member 19 to be peeled off of the second bonding portion 22b is set at 90° or less, whereby the sealing member 19 is peeled off of the second bonding portion 22b along the arrow D direction through the inclination peeling. Then, as shown in part (b) of FIG. 31, the sealing member 19 is peeled off of the second bonding portion 22b, so that the unsealing of the opening 35 is completed.

As another constitution in which the strength of the reinforcing portion 34e is ensured, as shown in FIG. 32, a constitution in which strength of the air-permeable portion 34b of the developer accommodating container 34 is enhanced may also be employed. Further, a constitution in which an adhesive 34f is applied onto the reinforcing portion 34e as shown in FIG. 33 and a constitution in which the reinforcing portion 34e is bonded with the adhesive 34f to the inner wall surface of the frame 18 of the developer accommodating unit 25 as shown in FIG. 31 may also be employed. As the adhesive 34f, a double-side tape and the like are appropriately selectable. Other constitutions are the same as those in the above-described embodiments, and a similar effect can be obtained.

### Fourth Embodiment

Next, with reference to (a) of FIGS. 35 and 38, a developer accommodating unit according to the present invention in a constitution in this embodiment will be described. Incidentally, constituent elements similar to those in the above-described embodiments will be omitted from description by adding the same reference numerals or symbols or by adding the same member (portion) names even when the reference numerals or symbols are different from those in the above-described embodiments.

FIG. 35 is a perspective view showing a state that a sealing member 19 of a developer accommodating member 37 in this embodiment is peeled off FIG. 36 is sectional view showing a structure of a developing device 38 including the developer accommodating member 37 in this embodiment.

FIG. 37 is a perspective view showing a state immediately before the sealing member 19 of the developer accommodating member 37 in this embodiment is unsealed. Parts (a) and (b) of FIG. 38 are perspective views showing a state of winding-up the sealing member by rotating an unsealing member 20 of the developer accommodating member 37 in this embodiment.

### <Sealing Member>

As shown in FIG. 35, the sealing member 19 seals up the developer accommodated in the developer accommodating container 34 by covering the opening 35 of the developer accommodating container 34 before use of the process cartridge A. The sealing member 19 is moved in the longitudinal direction of the opening 35 and thus is peeled off of the bonding portion 22, so that the opening 35 is exposed.

The sealing member 19 in this embodiment is provided with a free end portion 19e extending long to an outside of the bonding portion 22 in the longitudinal direction of the developer accommodating container 34 shown by the arrow F direction of FIG. 35 is provided. In the neighborhood of the free end portion 19e, the portion-to-be-engaged 19b comprising a through hole engaged with the engaging portion 20b of the unsealing member 20 shown in FIG. 37 is provided. On a side opposite from the portion-to-be-engaged 19b with respect to the longitudinal direction of the developer accommodating container 34 shown by the arrow F direction, a fold-back portion 19d which extends long to an outside of the bonding portion 22 and where the sealing member 19 is folded back is provided.

The sealing member 19 in this embodiment includes the fold-back portion 19d where the sealing member 19 is folded back from the outside of the third bonding portion 22c in an inside direction (a rightward direction of FIG. 35) with respect to the longitudinal direction of the developer accommodating container 34 shown by the arrow F direction of FIG. 35. Further, the sealing member 19 includes the free end portion 19e of the sealing member 19 folded back at the fold-back portion 19d is provided inside (left side in FIG. 15) an end portion 34a2, of the bottom 34a1 of the molded portion 34a, which is the other longitudinal end portion of the developer accommodating container 34.

When the unsealing member 20 is rotated in the arrow C direction, the sealing member 19 fixed at the portion-to-be-engaged 19b thereof to the engaging portion 20b of the unsealing member 20 is helically wound about an outer periphery of the unsealing member 20, so that the sealing member 19 is pulled in an arrow Q direction of FIG. 37 and thus is peeled from the bonding portion 22.

Here, the free end portion 19e of the sealing member 19 folded back at the fold-back portion 19d is provided with an region U between longitudinal ends of the molded portion 34a of the developer accommodating container 34. As a result, a feeding efficiency of the developer accommodating container 34 during transportation conveyance is enhanced. In addition, the free end portion 19e does not protrude from the longitudinal end of the developer accommodating container 34, and therefore, it is possible to prevent in advertent unsealing of the sealing member 19 during the transportation conveyance.

### <Unsealing Operation>

As shown in FIGS. 36 and 37, the developer accommodating member 37 constituted by including the developer accommodating container 34 and the sealing member 19 is accommodated in the frames 17 and 18. The portion-to-be-engaged 19b comprising the through hole of the sealing member 19 is engaged with the engaging portion 20b of the unsealing member 20 provided inside the frames 17 and 18.

In this embodiment, in order to facilitate assembling the developer accommodating unit 25, a constitution in which the engaging portion 20b of the unsealing member 20 is formed in a boss shape and the portion-to-be-engaged 19b is formed in a circular hole shape and in which these portions are engaged with each other is employed, but these portions may also be connected integrally with each other with an adhesive or the like. The fixed portion 34d comprising a through hole provided at a bonding portion 34g between the collar portion 34c and the air-permeable portion 34b of the molded portion 34a of the developer accommodating container 34 is engaged with the fixing portion 18a provided on the frame 18. The fixed portion 34d comprising the through hole is provided at a plurality of positions along the longitudinal direction of the developer accommodating container 34 shown by the arrow F direction of FIG. 35.

The unsealing operation of the opening 35 is performed by rotating the unsealing member 20 in the arrow C direction of FIG. 37. Then, the sealing member 19 including the portion-to-be-engaged 19b engaged with the engaging portion 20b of the unsealing member 20 is pulled in the arrow Q direction of FIG. 37 while being wound helically about the outer periphery of the unsealing member 20. As a result, the sealing member 19 is peeled in the arrow Q direction from the widthwise third bonding portion 22c positioned on the fold-back portion 19d side (left side in FIG. 37) of the sealing member 19.

The unsealing member 20 is further rotated in the arrow C direction. Then, as seen in part (a) of FIG. 38, the sealing member 19 is peeled from the first and second bonding portions 22a and 22b from the left side toward the right side (direction) of part (a) of FIG. 38 while being wound helically about the outer periphery of the unsealing member 20.

The peeling direction shown by the arrow Q direction was substantially parallel to the longitudinal direction of the opening 35 shown by the arrow F direction of FIG. 37 when the sealing member 19 is peeled from the widthwise third bonding portion 22c positioned on the fold-back portion 19d side (left side in FIG. 37) of the sealing member 19. Thereafter, a peeled portion of the sealing member 19 peeled from the first and second bonding portions 22a and 22b and a wound portion of the sealing member 19 wound helically about the outer periphery of the unsealing member 20 are close to each other. Correspondingly, the peeling direction shown by the arrow Q direction of part (a) of FIG. 38 gradually changes to a direction substantially perpendicular to the longitudinal direction of the opening 35 shown by the arrow F direction of (a) of FIG. 38.

With respect to the longitudinal direction of the opening 35 shown by the arrow F direction of part (a) of FIG. 38, the peeled portion of the sealing member 19 peeled from the first and second bonding portions 22a and 22b and the wound portion of the sealing member 19 wound helically about the outer periphery of the unsealing member 20 then reaches a position where these portions coincide with each other. Then, a winding direction of the sealing member 19 wound helically about the outer periphery of the unsealing member 20 is reversed, so that the sealing member 19 wound helically about the outer periphery of the unsealing member 20 is wound helically about the outer periphery thereof superposedly.

Finally, as shown by the arrow Q direction of part (b) of FIG. 38, a peeling direction of the sealing member 19 peeled from the widthwise fourth bonding portion 22d is a direction substantially perpendicular to the longitudinal direction of the opening 35 shown by the arrow F direction of part (a) of FIG. 38. Then, when the sealing member 19 is completely peeled off of the bonding portion 22, the opening 35 is unsealed, so that the unsealing operation is completed in a state in which the sealing member 19 is wound up about the outer periphery of the unsealing member 20.

The fixed portion 34d comprising the through hole fixed to the fixing portion 18a of the frame 18 is provided at a plurality of positions along the longitudinal direction of the opening 35 shown by the arrow F direction of FIG. 35. As a result, movement of the developer accommodating container 37 relative to the frame 38 by the peeling force by which the sealing member 19 is pulled in the arrow Q direction by being wound helically about the outer periphery of the unsealing member 20 rotating in the arrow C direction of parts (a) and (b) of FIG. 38.

Further, in the case where the sealing member 19 is wound helically about the outer periphery of the unsealing member 20, when the sealing member 19 is long more than necessary, an outer diameter of the unsealing member 20 in a state in which the sealing member 19 is wound about the outer periphery of the unsealing member 20 becomes large. For this reason, the unsealing member 20 in the state in which the sealing member 19 is wound about the outer periphery thereof opposes the opening 35 of the developer accommodating container 34, so that there is a possibility that the discharge of the developer through the opening 35 is impaired.

In this embodiment, the free end portion 19c of the sealing member 19 folded back at the fold-back portion 19d is disposed inside the end portion 34a2 of the bottom 34a1 (the plane including the opening 35) of the molded portion 34a of the developer accommodating container 34 with respect to the longitudinal direction. As a result, the outer diameter of the unsealing member 20 in the state in which the sealing member 19 is wound helically about the outer periphery of the unsealing member 20 can be minimized. As a result, the discharging property of the developer discharged through the opening 35 of the developer accommodating container 34 can be maintained. Other constitutions are the same as those in the above-described embodiments, and a similar effect can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-199995 filed on Oct. 16, 2017, which is hereby incorporated by reference herein in its entirety.

What is claimed is:

1. A developer accommodating member for accommodating a developer, comprising:
a flexible container provided with a single opening for permitting discharge of the developer;
a sealing member bonded to a periphery of said opening and configured to seal said opening;
a bonding portion bonding the periphery of said opening and said sealing member; and
a reinforcing member,
wherein said container includes a fixing portion fixable in a neighborhood of said opening,
wherein said opening is formed so as to extend in a longitudinal direction of said container, and
wherein said reinforcing member is provided on a side opposite from said fixing portion with respect to said opening, and as seen in a direction perpendicular to a plane including said opening, said bonding portion and said reinforcing member at least partially overlap with each other.

2. A developer accommodating member according to claim 1, wherein said reinforcing member extends in the longitudinal direction.

3. A developer accommodating member according to claim 1, wherein said reinforcing member includes,
a portion provided on a side opposite from said fixing portion with respect to said opening, and
a portion extending from said portion, provided on the side opposite from said fixing portion with respect to said opening, toward said fixing portion.

4. A developer accommodating member according to claim 1, further comprising a portion extending from a portion, provided on a side opposite from said fixing portion.

5. A developer accommodating unit comprising:
a developer accommodating member according to claim 1; and
an unsealing member configured to peel said sealing member from said bonding portion by moving said sealing member.

6. A developing device comprising:
a developer accommodating unit according to claim 5; and
a developer carrying member configured to carry a developer.

7. A process cartridge comprising:
a developing device according to claim 6; and
an image bearing member configured to bear an electrostatic latent image.

8. An image forming apparatus comprising:
a developing device according to claim 6; and
image forming means configured to form an image on a recording material.

9. A developer accommodating member for accommodating a developer, comprising:
a flexible container provided with a single opening for permitting discharge of the developer;
a sealing member bonded to a periphery of said opening and configured to seal said opening;
a bonding portion bonding the periphery of said opening and said sealing member; and
wherein said bonding portion includes,
a first bonding portion positioned upstream of said sealing member with respect to an unsealing direction,
a second bonding portion positioned downstream of said sealing member with respect to the unsealing direction, and
third and fourth bonding portions each connecting associated end portions of said first and second bonding portions,
wherein said opening is formed so as to extend in a longitudinal direction of said container, and
wherein said container includes,
a fixing portion fixable in a neighborhood of said opening, and
a reinforcing portion provided in a region enclosed by a region ranging from a downstream end portion of said fixing portion to an unseal end portion of said second bonding portion with respect to the unsealing direction of said sealing member and a region between end portions of said third and fourth bonding portions with respect to a longitudinal direction of said container.

10. A developer accommodating unit comprising:
a developer accommodating member according to claim 9; and
an unsealing member configured to peel said sealing member from said bonding portion by moving said sealing member.

11. A developing device comprising:
a developer accommodating unit according to claim 10; and
a developer carrying member configured to carry a developer.

12. A process cartridge comprising:
a developing device according to claim 11; and
an image bearing member configured to bear an electrostatic latent image.

13. An image forming apparatus comprising:
a developing device according to claim 11; and
image forming means configured to form an image on a recording material.

14. A developer accommodating member for accommodating a developer, comprising:
a flexible container provided with a single opening for permitting discharge of the developer;
a sealing member bonded to a periphery of said opening and configured to seal said opening; and
a bonding portion bonding the periphery of said opening and said sealing member,
wherein said container includes a fixing portion fixable in a neighborhood of said opening,
wherein said opening is formed so as to extend in a longitudinal direction of said container,
wherein said sealing member includes a fold-back portion where said sealing member is folded back from an outside of said bonding portion toward an inside of said bonding portion with respect to the longitudinal direction, and
wherein a free end portion of said sealing member folded back at said fold-back portion is provided inside the other end portion of said sealing member with respect to the longitudinal direction of said container.

15. A developer accommodating unit comprising:
a developer accommodating member according to claim 14; and
an unsealing member configured to peel said sealing member from said bonding portion by moving said sealing member.

16. A developing device comprising:
a developer accommodating unit according to claim 15; and
a developer carrying member configured to carry a developer.

17. A process cartridge comprising:
a developing device according to claim 16; and
an image bearing member configured to bear an electrostatic latent image.

18. An image forming apparatus comprising:
a developing device according to claim 16; and
image forming means configured to form an image on a recording material.
